(19) United States
(12) Patent Application Publication
(10) Pub. No.: US 2015/0367149 A1
(43) Pub. Date: Dec. 24, 2015

(54) COBINAMIDE-BASED MATERIALS FOR OPTICAL SENSING AND GAS REMOVAL

(71) Applicants: The United States of America, as represented by the Secretary, Dept. of Health and Human Services, Bethesda, MD (US); The Regents of the University of California, Oakland, CA (US)

(72) Inventors: Lee A. Greenawald, Morgantown, WV (US); Gerry R. Boss, La Jolla, CA (US); Nicole Fry, Pacific Beach, CA (US); Michael J. Sailor, La Jolla, CA (US); Matthew Brenner, Irvine, CA (US); Sari B. Mahon, Irvine, CA (US)

(73) Assignees: The United States of America as represented by the Secretary, Department of Health and Human Service; The Regents of the University of California

(21) Appl. No.: 14/748,163

(22) Filed: Jun. 23, 2015

Related U.S. Application Data
(60) Provisional application No. 62/016,565, filed on Jun. 24, 2014.

(51) Int. Cl. A62B 9/00; A62B 23/02; G01N 21/78; A62B 7/10

(52) U.S. Cl. CPC A62B 9/006; A62B 7/10; A62B 23/02; G01N 21/783; G01N 2021/7783

(57) ABSTRACT

This disclosure concerns materials for detecting and removing gaseous chemical agents (e.g., cyanide, cyanogen, sulfide, nitrite, nitric oxide, and combinations thereof), devices including the materials, and methods of making and using the disclosed materials. Embodiments of the disclosed materials include a support material impregnated with cobinamide and/or a cobinamide derivative.

### CROSS REFERENCE TO RELATED APPLICATION

This application claims the benefit of the earlier filing date of U.S. Provisional Application No. 62/016,565, filed Jun. 24, 2014, which is incorporated in its entirety herein by reference.

### FIELD

This disclosure concerns a sensor for rapid detection of low concentrations of gaseous chemical agents, devices including the sensor, and methods of making and using the sensor.

### ACKNOWLEDGMENT OF GOVERNMENT SUPPORT

This invention was made with government support under U01 058030 awarded by NIH-NINDS. The government has certain rights in the invention.

### BACKGROUND

The National Institute for Occupational Safety and Health (NIOSH) defines a level of 50 ppm as Immediately Dangerous to Life or Health (IDLH) for hydrogen cyanide gas (HCN). HCN is present in manufacturing industries such as electroplating, mining, production of paper, textiles, plastics and pesticides. It is considered a potential chemical warfare agent, having been used in both World Wars I and II, and it has been used in recent terrorist attacks.

NIOSH designates maximum exposure limits for many occupational hazard gases. A short-term exposure limit (STEL) is a 15 minute time-weighted average that should not be exceeded at any time during a ten hour work day. HCN has a STEL of 4.7 ppm.

In occupational or military settings, persons who may be exposed to HCN are required to wear a Self-Contained Breathing Apparatus (SCBA) or an Air-Purifying Respirator (APR) fitted with a chemical, biological, radiological, nuclear (CBRN) NIOSH-approved canister. It is often difficult for users to determine when the activated carbon bed in such a canister becomes saturated and ceases to provide adequate protection, i.e., when the canister reaches its “end-of-service-life” (ESL). The smell or irritation of a gas has been used to indicate breakthrough, but by the time a user can smell a gas, dangerous concentrations may already be present. Software models provided by manufacturers are currently used to help users estimate when breakthrough will occur. Unfortunately, unpredictable input data such as types and concentrations of toxic chemicals, relative humidity, and breathing rate may not be readily available to the user. In addition, most of the theoretical models incorporated into the software are for organic vapors

In 1984, NIOSH published standards for certification of sensors indicating breakthrough (termed “end-of-service-life indicators” or ESLIs,) to encourage their development. The sensors are intended to provide a real-time alert to indicate to the user that the canister is near its maximum absorption capacity and vapor breakthrough is imminent. Current challenges in developing these sensors include the effects of humidity, as well as size, weight, and power restrictions for incorporation into respirators. Additionally, manufacturers prefer to limit costs to no more than $1/canister for the sensor or $20-$50 for the sensor-related fixturing and electronics per respirator. Only a few colorimetric and qualitative ESLIs are available (such as for mercury vapor), and these rely on subjective visual detection to identify a color change. These are inappropriate in poorly-lit environments or for color blind persons.

### SUMMARY

A sensor for detecting gaseous chemical agents comprises a support material and an effective amount of cobinamide and/or a cobinamide derivative impregnated within the support material. In some embodiments, the cobinamide derivative is monocyanocobinamide. Suitable support materials include a glass fiber paper, a cellulose paper, a silica matrix, carbon, titania, or alumina. In some embodiments, the effective amount is within a range of 0.005-0.5 nmol/mm³, based on a volume of the support material.

A respirator canister comprises a housing, a sorbent filter disposed within the housing, an end-of-life sensor comprising a support material and an effective amount of cobinamide and/or a cobinamide derivative impregnated within the support material, and a detector for measuring absorbance or reflectance of light by the sensor, wherein changes in the absorbance or reflectance of light reaching the detector are indicative of the sorptive capacity of the sorbent filter. The end-of-life sensor may be disposed in the housing or secured externally to the housing.

In any or all of the above embodiments, the respirator canister may also include a visual and/or audible indicator configured to indicate when an absorbance of light measured by the sensor reflects a concentration of cyanide and/or other gaseous chemical agents that exceeds a threshold amount. In any or all of the above embodiments, the respirator canister may further include a light source for irradiating the sensor and an optical fiber having a first end in optical communication with the sensor and a second end in optical communication with the light source. The optical fiber may be bifurcated so that the second end includes at least two end portions, one of the end portions optically communicating with the light source and the other of the end portions optically communicating with the detector. In any or all of the above embodiments, the detector may include a spectrometer.

A method for detecting an analyte includes contacting a sample comprising an analyte capable of binding to cobinamide and/or a cobinamide derivative with a sensor comprising a support material and an effective amount of cobinamide and/or the cobinamide derivative impregnated within the support material, and detecting a change in the color of the sensor. Detecting a change in color of the sensor may include measuring the absorbance or reflectance of light by the sensor. In some embodiments, the analyte is cyanide, cyanogen, sulfide, nitrite, nitric oxide, or a combination thereof. When the analyte is cyanide, the sensor may comprise monocyanocobinamide. In any or all of the above embodiments, the effective amount may be within a range of 0.005-0.5 nmol/mm³, based on a volume of the support material.

A method for removing gaseous chemical agents from an environment includes providing a sensor that comprises a support material and an effective amount of cobinamide and/or a cobinamide derivative impregnated within the support material, and exposing the sensor to the environment, whereby the cobinamide and/or the cobinamide derivative binds to a gaseous chemical agent in the environment. In some embodiments, the gaseous chemical agent is cyanide, cyanogen, sulfide, nitrite, nitric oxide, or a combination thereof. In any or all of the above embodiments, the environment may comprise an interior space of a respirator canister. In any or all of the above embodiments, the effective amount may be within a range of 0.005-0.5 nmol/mm³, based on a volume of the support material.

The foregoing and other objects, features, and advantages of the invention will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows absorbance spectra of 25 μM dihydroxocobinamide in 0.1 M NaOH upon binding 10-100 μM KCN; as the concentration of KCN increases, dihydroxocobinamide transitions to complexed dicyanocobinamide.

FIG. 2 shows absorbance spectra of 0-300 μM Na₂S after reaction with 50 μM cobinamide in 1 mM NaOH solution immediately after reagents were mixed.

FIG. 3 shows absorbance spectra for the reaction of cobinamide with NO; (a) spectrum obtained after cobinamide (21 μM) in 0.1 M phosphate buffer, pH 7.4., was deoxygenated; (b) spectrum obtained after reaction with 1946 μM NO.

FIG. 4A is a color photograph of silica pellets loaded with cyanoaquocobinamide.

FIG. 4B shows absorbance spectra of a 50 μM cobinamide solution (dashed line) and cobinamide encapsulated in a silica pellet (solid line).

FIG. 5A is a color photograph of a cyanoaquocobinamide-doped silica pellet before (left, orange pellet) and after (right, purple pellet) treatment with hydrogen cyanide gas.

FIG. 5B shows absorbance spectra of the pellet of FIG. 5A before (solid line) and after (dashed line) treatment with hydrogen cyanide gas.

FIG. 6A is a perspective view of exemplary sensor holder, constructed to hold a cobinamide-based sensor and, optionally, a mirror for reflectance purposes, and

FIG. 6B is a top plan view of the disassembled sensor holder.

FIG. 7 is a perspective view of an exemplary cobinamide-based sensor in a holder attached externally to a respirator canister. A bifurcated fiber optic cable is attached to the sensor holder and connected to a spectrometer and a light source.

FIGS. 8A-8C show embodiments of an exemplary cobinamide-based sensor holder. FIG. 8A is a perspective view showing filter paper inserted into the holder; FIG. 8B is a perspective view of the assembled flow-through sensor holder; FIG. 8C is a top plan view of the disassembled sensor holder.

FIG. 9 is a schematic illustration of an experimental setup for HCN gas exposure.

FIG. 10 is a color photograph illustrating the differences between acid and base sol-gel solutions of tetraethylorthosilicate, ethanol, water, cobinamide, and a surfactant.

FIG. 11 is a color photograph showing cobinamide-doped silica-based sol-gel pellets before (left image) and after (right image) exposure to HCN.

FIG. 12 shows absorbance spectra of 3 cobinamide complexes: OH(H₂O)Cbi (solid line), CN(H₂O)Cbi (dotted line), and (CN)₂Cbi (dashed line).

FIG. 13 shows a comparison of a monocyanocobinamide (CN(H₂O)Cbi) solution spectrum (solid line) and diffuse reflectance spectra on cellulose (dashed line) and glass fiber (dotted line) filter paper. The Kubelka Munk function is plotted for the diffuse reflectance spectra.

FIG. 14 shows a comparison of a CN(H₂O)Cbi solution spectra and diffuse reflectance spectra on glass fiber paper. Solution spectra for 20 μM CN(H₂O)Cbi in solution before excess KCN is added (solid line) and after KCN is added (short dashed line). Diffuse reflectance spectra for CN(H₂O)Cbi on glass fiber for excess HCN gas is introduced (dotted line) and after HCN exposure (long dashed line).

FIG. 15 shows diffuse reflectance spectra of CN(H₂O)Cbi response on cellulose filter paper before exposure to 5 ppm HCN (solid line), after 1 minute of exposure to 5 ppm HCN exposure (dotted line), and after 5 minutes of exposure (dashed line).

FIG. 16 shows diffuse reflectance spectra when the reflectance spectrum of CN(H₂O)Cbi on cellulose filter paper was designated as the “blank” (solid line), after 1 min exposure to 5 ppm HCN (dotted line), after 5 min exposure (short dashed line), and after 60 min exposure (long dashed line).

FIG. 17 shows diffuse reflectance spectra illustrating the response of CN(H₂O)Cbi on cellulose paper to 1 and 5 ppm HCN. The spectra illustrate the 5 ppm HCN response at 583 nm (solid line), 1 ppm HCN response at 583 nm (dotted line), 5 ppm HCN response to the average of signal over 400-450 nm (long dashed line), and 1 ppm HCN response to the average of 400-450 nm (short dashed line).

FIG. 18 is an expanded version of a portion of the data in FIG. 17 showing the initial response (in seconds) to 5 ppm HCN (solid line) and 1 ppm HCN (dotted line) at 583 nm.

FIG. 19 shows diffuse reflectance spectra illustrating the CN(H₂O)Cbi response to 5 ppm HCN exposure on glass fiber filter paper as a function of time of exposure. CN(H₂O)Cbi before HCN exposure (solid line), and 1 minute of exposure (dotted line), 5 min of exposure (short dashed line), 10 min exposure (long dashed line) and 15 min exposure (double line).

FIG. 20 shows diffuse reflectance spectra illustrating the changes in spectra when the reflectance spectrum of CN(H₂O)Cbi on glass fiber filter paper was designated as the “blank” (solid line), and after exposure to 5 ppm HCN for 1 min (dotted liner), 5 min (short dashed line), 10 min (long dashed line), and 15 min (double line).

FIG. 21 shows diffuse reflectance spectra illustrating the CN(H₂O)Cbi on glass fiber paper response to 1 ppm HCN (dotted line) and 5 ppm HCN (solid line) at 583 nm.

FIG. 22 is an expanded version of a portion of the data in FIG. 21 showing the initial response (in seconds) to 1 ppm HCN (dotted line) and 5 ppm HCN (solid line) at 583 nm.

FIG. 23 is a comparison of the average response of CN(H₂O)Cbi on cellulose filter paper (solid line) and glass fiber filter paper (dashed line) when exposed to 5 ppm HCN for 1, 5, 10, and 15 min. Error bars are represented by 95% C.I. using n=3 for cellulose paper and n=6 for glass fiber filter paper.

FIG. 24 shows the average response of CN(H₂O)Cbi on cellulose filter paper to 5 ppm HCN at various exposure times. Error bars are represented by 95% C.I. using n=3.

FIG. 25 shows the average response of CN(H₂O)Cbi on glass fiber filter paper to 5 ppm HCN at various exposure times. Error bars are represented by 95% C.I. using n=6.

FIG. 26 shows the average response of CN(H₂O)Cbi on glass fiber filter paper as a function of concentration for 1 minute exposure time. Error bars are represented by 95% C.I. for n=3.

FIG. 27 shows the average response of CN(H₂O)Cbi on glass fiber filter paper as a function of concentration for 15 minutes exposure time. Error bars are represented by 95% C.I. for n=3.

FIG. 28 shows the average response of CN(H₂O)Cbi on cellulose filter paper to 5 ppm HCN gas as a function of time of exposure at 25% RH (♦), 50% RH (▪) and 85% RH (▴). Error bars are represented by 95% C.I. for n=3.

FIG. 29 shows the average initial response of CN(H₂O)Cbi on cellulose filter paper to 5 ppm HCN at various relative humidities: 25% RH (♦), 50% RH (▪) and 85% RH (▴). N=3.

FIG. 30 shows the response of CN(H₂O)Cbi on cellulose filter paper to 5 ppm HCN at various relative humidities (25% (solid line), 50% (dotted line), and 85% (dashed line) RH) at 583 nm and the average response at 400-450 nm.

FIG. 31 shows the average response of CN(H₂O)Cbi on glass fiber filter paper to 5 ppm HCN at various exposure times at 25% RH (♦), 50% RH (▪) and 85% RH (▴). Error bars are represented by 95% C.I. using n=3 for 50% and 85% RH and n=6 for 25% RH.

FIG. 32 shows the average initial response of CN(H₂O)Cbi on glass fiber filter paper to 5 ppm HCN at various relative humidities: 25% RH (♦), 50% RH (▪) and 85% RH (▴). N=3.

FIG. 33 shows the response of cobinamide on glass fiber filter paper to 10.0 ppm H₂S.

FIG. 34 is a graph comparing breakthrough detection of H₂S by an exemplary embodiment of a cobinamide-based sensor compared to a H₂S-specific electrochemical detector.

### DETAILED DESCRIPTION

This disclosure concerns materials for detecting and removing gaseous chemical agents (e.g., cyanide, cyanogen (CN)₂, sulfide, nitrite, nitric oxide, and combinations thereof), devices including the materials, and methods of making and using the disclosed materials. Embodiments of the disclosed materials include cobinamide and/or cobinamide derivatives. As discussed in U.S. Pat. No. 8,741,658, which is hereby incorporated by reference in its entirety, cobinamide has been used to detect cyanide using colorimetric analysis.

Any terms not directly defined herein shall be understood to have the meanings commonly associated with them as understood within the art of the invention. Certain terms are discussed herein to provide additional guidance to the practitioner in describing the compositions, devices, methods and the like of aspects of the invention, and how to make or use them. It will be appreciated that the same thing may be said in more than one way. Consequently, alternative language and synonyms may be used for anyone or more of the terms discussed herein. No significance is to be placed upon whether or not a term is elaborated or discussed herein. Some synonyms or substitutable methods, materials and the like are provided. Recital of one or a few synonyms or equivalents does not exclude use of other synonyms or equivalents, unless it is explicitly stated. Use of examples, including examples of terms, is for illustrative purposes only and does not limit the scope and meaning of the aspects of the invention herein.

It must be noted that, as used in the specification, the singular forms “a,” “an,” and “the” include plural referents unless the context clearly dictates otherwise.

Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context if properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

### I. COBINAMIDE-LOADED SUPPORT MATERIALS

Cobinamide (Cbi), a cobalt-centered hydroxocobalamin analog, can bind up to two cyanide (CN⁻) ions. The structure is shown below, where the X and Y ligands can be OH⁻, H₂O, or CN⁻.

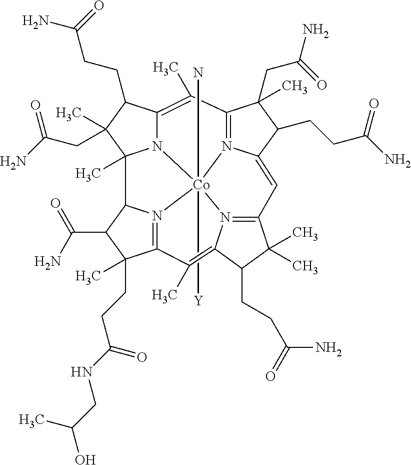

Cyanide ion rapidly displaces a water or hydroxyl ligand on cobinamide, with an overall Kₐ value of 10²² M⁻² (compared to a Kₐ value of 10¹² M⁻¹ for hydroxocobalamin). At neutral pH in water, Cbi exists as the mixed hydroxy-aquo complex OH(H₂O)Cbi, termed aquohydroxocobinamide. As noted by Baldwin et al. (J. of Chem. Soc. Dalton Trans. 1983, 217-223) and further shown by Ma et al. (Analytica Chimica Acta 2012, 736:78-84), more rapid and more pronounced spectral changes occur on CN⁻ binding when starting with monocyanocobinamide [CN(H₂O)Cbi] than when starting with either diaquacobinamide or aquohydroxocobinamide; this is attributed to the stronger trans-labilizing effect of CN⁻ compared to OH⁻. The change from CN(H₂O)Cbi to dicyanocobinamide [(CN)₂Cbi] yields a significant color change from orange (peak absorbance at ˜510 nm) to violet (583 nm) that is easily observed. Complexing of CN(H₂O)Cbi with CN⁻ can be detected at concentrations as low as 0.25 nM of cyanide in solution.

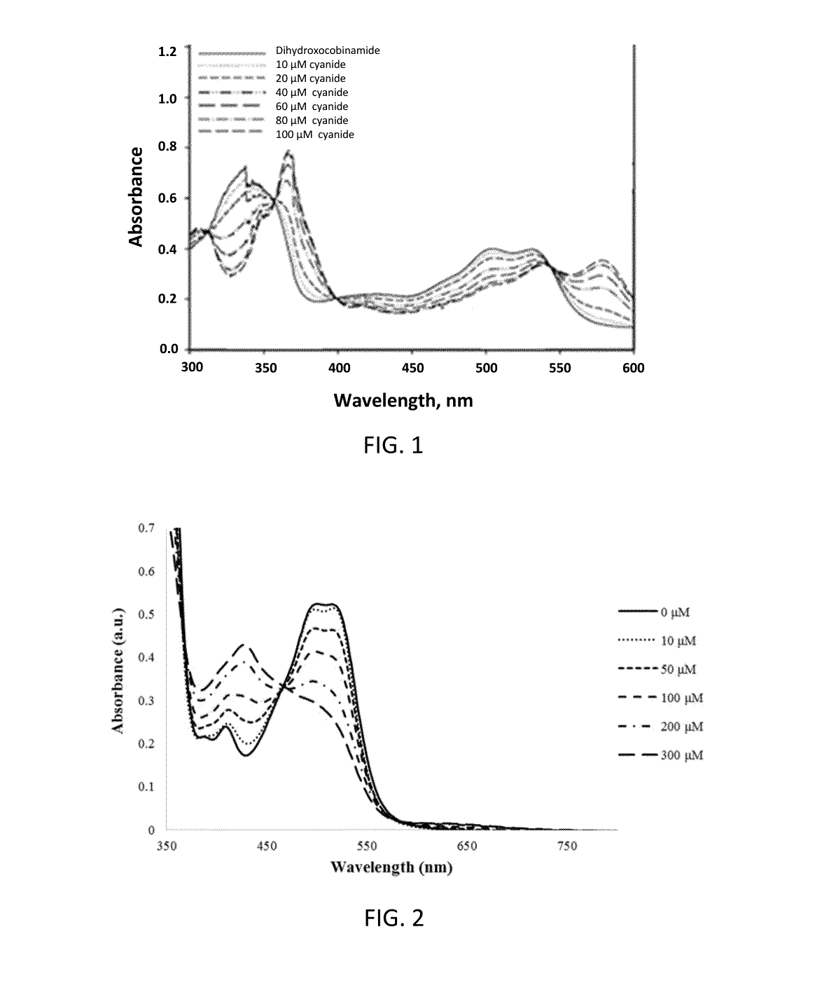

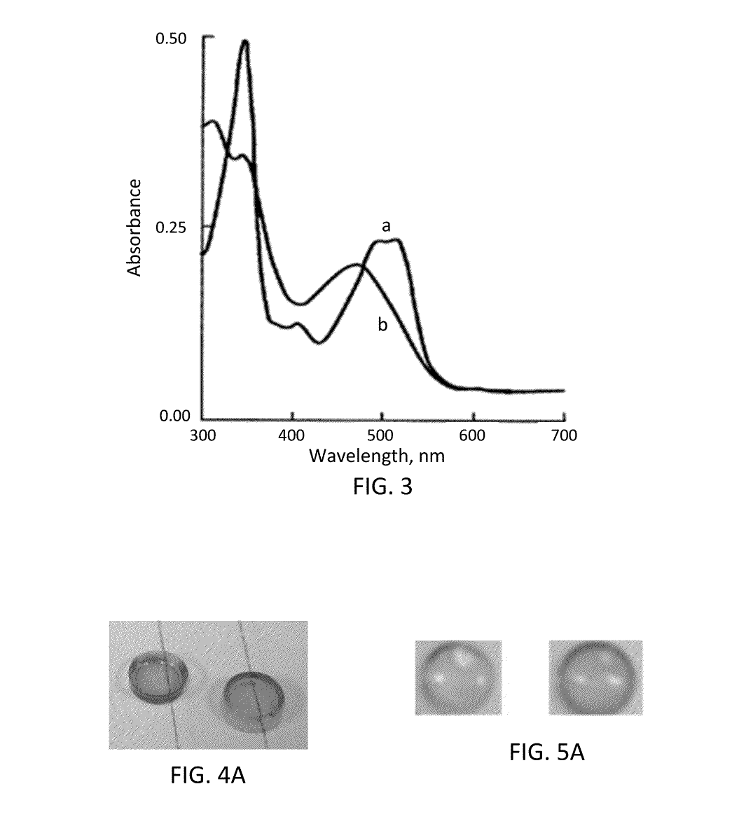

Cobinamide has different absorbance spectra depending on the type of ligands bound in the two axial positions of the cobalt metal center. FIGS. 1-3 show how the absorbance spectrum of cobinamide changes as cyanide, sulfide, or nitric oxide ligands bind, respectively. FIG. 1 shows spectral changes of dihydroxocobinamide on binding cyanide. The ultraviolet/visible wavelength spectra of cobinamide (solid line) in 0.1 M NaOH is shown during transition to complexed dicyanocobinamide (dashed line). Serial addition of KCN to 25 μM cobinamide gradually changes the spectrum to dicyanocobinamide. Shown are cyanide concentrations of 10 μM to 100 μM. FIG. 2 illustrates spectra of 0-300 μM Na₂S after reaction with 50 μM cobinamide in 1 mM NaOH solution immediately after reagents were mixed. FIG. 3 illustrates the reaction of cobinamide with nitric oxide (NO). Curve (a) shows a spectrum obtained after cobinamide (21 μM) in 0.1 M phosphate buffer, at pH 7.4, was deoxygenated. Curve (b) shows the spectrum obtained after reaction with 1946 μM NO. The spectral changes with addition of sulfide and nitric oxide are different than those observed with cyanide addition.

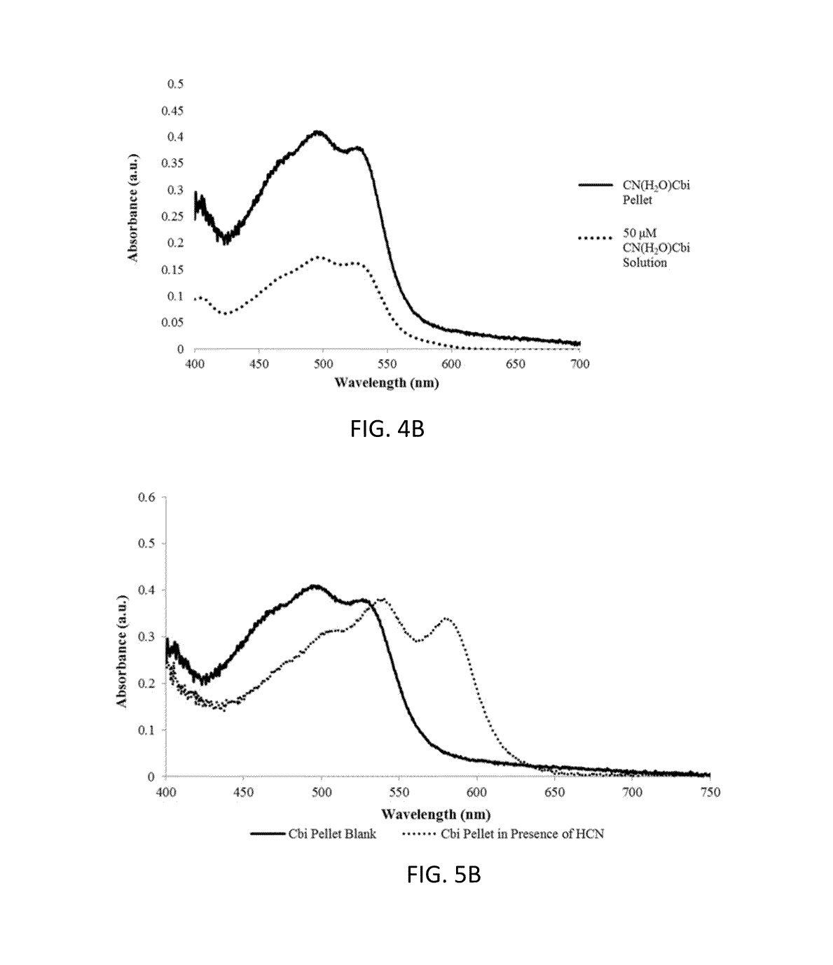

Changes at several different wavelengths can be monitored over time and used to monitor the presence of the different ligands. For example, the shape of the absorbance spectrum of cobinamide is not affected when cobinamide is loaded within a transparent silica matrix and formed into a pellet (e.g., 6 mm diameter and 0.250 mm thick), as shown in FIG. 4, where FIG. 4A shows silica pellets loaded with cyanoaquocobinamide, and FIG. 4B shows the absorbance spectra of 20 μM cobinamide solution (lower spectrum) and 100 μM cobinamide encapsulated in a silica pellet (upper spectrum).

Cobinamide molecules (with various combinations of axial ligands: H₂O, OH⁻, NO₂⁻, CN⁻) are immobilized within and/or impregnated into a support material to form a sensor. In some embodiments, when the material will be used to detect cyanide, the cobinamide molecule is monocyanocobinamide (also known as cyanoaquocobinamide). The support material is a material that is able to adsorb a sufficient quantity of cobinamide to be detectable optically, and that does not substantially degrade the cobinamide molecule upon adsorption. Suitable support materials include porous support materials such as, for example, a silica matrix, cellulose paper, carbon (e.g., activated carbon), titania, alumina, or glass fiber paper. In some embodiments, the cellulose or glass fiber paper is a cellulose or glass fiber filter paper. The support materials allow infiltration of the analyte(s). In one embodiment, the support material is a silica matrix. In an independent embodiment, the support material is a glass fiber paper, such as a glass fiber filter paper. The analyte(s) bind to the cobinamide molecule, resulting in a color change (more particularly, a shift in the cobinamide's absorbance spectrum and/or reflectance spectrum) that can be qualitatively or quantitatively analyzed colorimetrically. Using a light source and spectrometer (e.g., a miniature spectrometer), specific wavelengths may be monitored to quantify the amount of analyte that binds over time.

The cobinamide-loaded support material comprises an effective amount of the cobinamide or cobinamide derivative (e.g., monocyanocobinamide). An effective amount is an amount sufficient to provide rapid detection (i.e., within minutes) of analyte concentrations at or above recommended exposure levels. In some embodiments, the amount is effective to provide rapid detection of analyte concentrations less than 10 ppm, such as analyte concentrations from 1-5 ppm. The effective amount may be within a range of 0.005-0.5 nmol/mm³, such as 0.01-0.5 nmol/mm³, 0.05-0.2 nmol/mm³, or 0.07-0.12 nmol/mm³, based on a volume of the support material.

Embodiments of the disclosed cobinamide-loaded support materials can rapidly detect analytes, including CN⁻, S²⁻, NO, NO₂⁻, and combinations thereof. In some embodiments, detection occurs in less than two minutes, such as within one minute, within 30 seconds, within 15 seconds, or even within 10 seconds. In one embodiment, low levels (below recommended exposure limits) of H₂S are detected within one minute. In an independent embodiment, low levels (e.g., 5 ppm) of HCN are detected within ten seconds. Response time may decrease as relative humidity levels increase.

### III. DEVICES INCLUDING A COBINAMIDE-LOADED SUPPORT MATERIAL

A cobinamide-loaded support material can be incorporated into a respirator canister such as a Chemical, Biological, Radiological and Nuclear (CBRN) canister, which is designed to protect workers against chemical, biological, radiological and nuclear weapons. Respirator canisters typically include a gas/vapor sorbent bed for adsorption of toxic airborne material. A canister's time of use is limited by its adsorption capacity and use parameters, such as the type of substance being removed, the concentration of the substance being removed, the ambient temperature and humidity at the time of removal, carbon porosity, and the air-flow rate. A change schedule, sometimes called a ‘change-out’ schedule, is the calculated time interval for protection against gas/vapors, after which a used canister is replaced with a new one.

To ensure that the adsorption capacity of a respirator canister is not exceeded, an end-of-service-life indicator (ESLI) may be employed. Current ESLIs on the market are considered “Passive ESLIs”, meaning it is up to the user to monitor a color change via a colorimetric indicator, viewed through a clear box on the outside of the gas mask canister. This is an issue for color-blind persons, in low-light settings, or if the user is preoccupied and is not continuously monitoring the ESLI for a color change on the respirator canister.

In accordance with one aspect of this disclosure, an “Active ESLI” is provided, which means that a visual and/or audible indicator or alarm will alert the user when it is appropriate to change the gas mask canister due to a certain threshold of analyte(s) or analyte concentration being reached in the carbon bed of the gas mask canister. The ESLI indicator may be based on a cobinamide-loaded support material. Changes in the absorbance spectrum of the cobinamide/support material within the respirator canister can be monitored and, once a particular concentration of the analyte(s) is detected and meets a certain threshold, a visual and/or audible alarm will go off, indicating that the canister needs to be replaced. Since the analyte(s) bind to the cobinamide, such material can also be embedded into respirator canisters to help facilitate the removal of the toxic analyte(s) from the air that is taken in by the user. In this way the cobinamide molecules within the canister can provide simultaneous specific toxic analyte removal and an indication of exhaustion/saturation of the cobinamide material's ability to absorb the toxic analyte, including, but not limited to, cyanide, cyanogen, sulfide, nitrite, nitric oxide, and combinations thereof.

For a HCN-specific ESLI, a response to 5 ppm HCN must occur within minutes. The distinct and rapid color change that occurs when cobinamide binds to CN⁻ allows use of a cobinamide-containing material to produce a diffuse reflectance device that detects concentrations of HCN gas in the ppm range. Detection can occur in less than two minutes. In some embodiments, detection occurs in less than one minute, such as within ten seconds.

A major issue with current gas sensors is their susceptibility to moisture, leading to inaccurate measurements. For instance, gas sensors for hydrogen cyanide gas are based on electrochemical technology and lack specificity, have negative moisture effects, and can be too bulky/expensive to be incorporated into a respirator canister. Embodiments of the disclosed support materials and cobinamide are significantly less affected by moisture, leading to more accurate measurement of analyte(s). This is important for an ESLI within gas masks that will be worn in various climates around the world. In order for ESLIs to be commercially successful, they must be small enough in size so as to not add a significant amount of weight to the canister and thus affect the comfort of the user.

Cobinamide-loaded support materials can be incorporated as active absorbent/neutralizing agents in gas masks or other respirator canisters, providing specific neutralization of toxic agents. These canisters are useful in high-risk-exposure industrial situations, and can be made available for use by responders to analyte exposures, including in chemical manufacturing facilities (e.g., cyanide, cyanogen, sulfide, nitrite, and nitric oxide), and oil and gas operations (e.g., H₂S). Only small amounts of cobinamide are required to bind the analyte(s) to observe changes in the cobinamide absorbance spectrum necessary for detection of analyte(s), and therefore the cobinamide-containing material will not add significant weight to the canister.

By encapsulating or impregnating the cobinamide molecules within a support material (such as a silica matrix, cellulose filter paper, or glass fiber filter paper), several parameters related to analyte detection may be improved, including:
1) decreased degradation of the cobinamide molecule before and after analyte binding;
2) increased control of cobinamide concentration at specific locations;
3) decreased limit of detection; and
4) increased response times.

In some embodiments, using the color changes caused by analyte(s) binding to the cobinamide materials provides an accurate measurement of the amount of analyte(s) being incorporated into the canister, if the cobinamide material is part of the material within the respirator canisters that is responsible for the removal of the toxic analytes(s).

In some embodiments, the support material is silica. Silica pellets may be porous and may allow the diffusion of gases through the matrix and facilitate binding of the analyte(s) with the immobilized cobinamide. FIG. 5 demonstrates that hydrogen cyanide gas can infiltrate the silica matrix and bind to the cobinamide molecule, resulting in a visible color change of the pellet from orange (cyano-aquocobinamide) to purple (dicyanocobinamide). In particular, FIG. 5A shows a cyanoaquocobinamide-doped silica pellet before (left, orange pellet), and after (right, purple pellet) treatment with hydrogen cyanide gas. FIG. 5B shows the absorbance spectra of the same pellet before and after treatment with hydrogen cyanide gas.

In some embodiments, the support material is paper. Paper (e.g., cellulose filter paper or glass fiber filter paper) is a promising substrate for real-time, low-cost sensors. It is light in weight, easily adapted to varied size and shape requirements, compatible with chemicals of various matrices and has high wicking capability. Paper is also highly porous with a large surface area, which is advantageous for rapid adsorption of gas-phase analytes. The wide abundance of paper makes it a suitable support medium to incorporate into an economical and portable sensor.

One possible end-of-service-life sensor design is based on optical measurement of a colored compound dispersed on a white medium. The availability of small photodetectors, inexpensive optical fibers, and low-power LED light sources suggest that a simple diffuse reflectance configuration could satisfy the size, cost, and power requirements of an active ESLI, while paper is inexpensive and easily obtainable. Common sample media for diffuse reflectance include soil, paint, body tissues, crystals, and paper. To obtain a linear relationship of spectral intensity to sample concentration, the Kubelka-Munk equation may be applied:

$$F ( R ) = \frac{{( 1 - R )}^{2}}{2 R} = K / S \qquad Equation 1$$

where R is reflectance, K is the absorption coefficient and S is the scattering coefficient. The Kubelka-Munk formula is the most common approach to interpret diffuse reflectance and make the data comparable to that of transmittance.

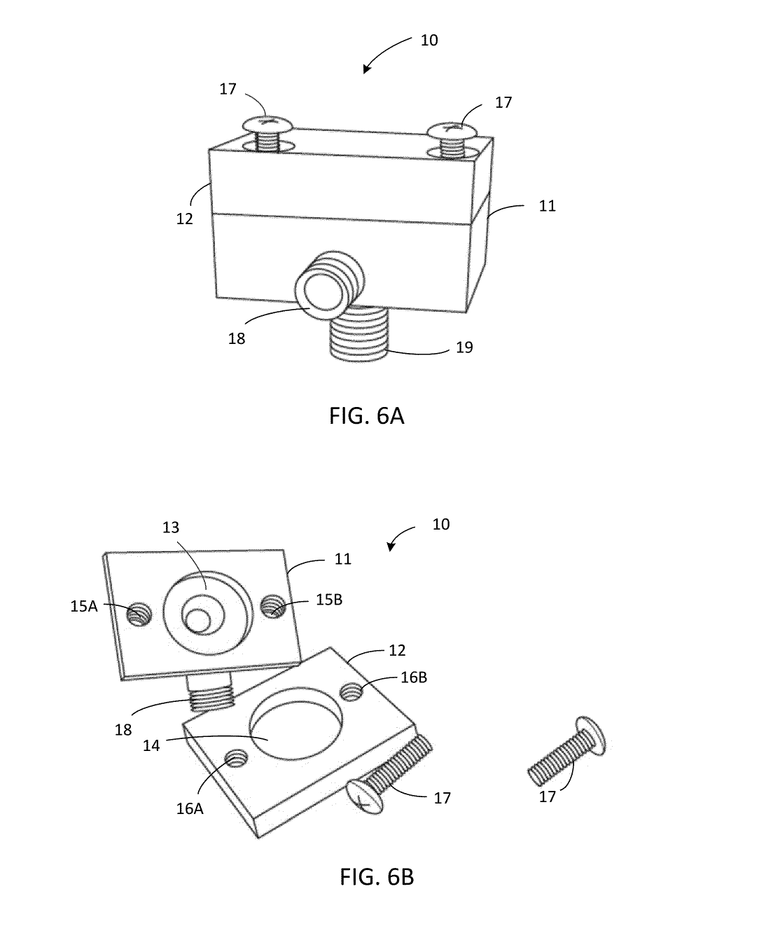

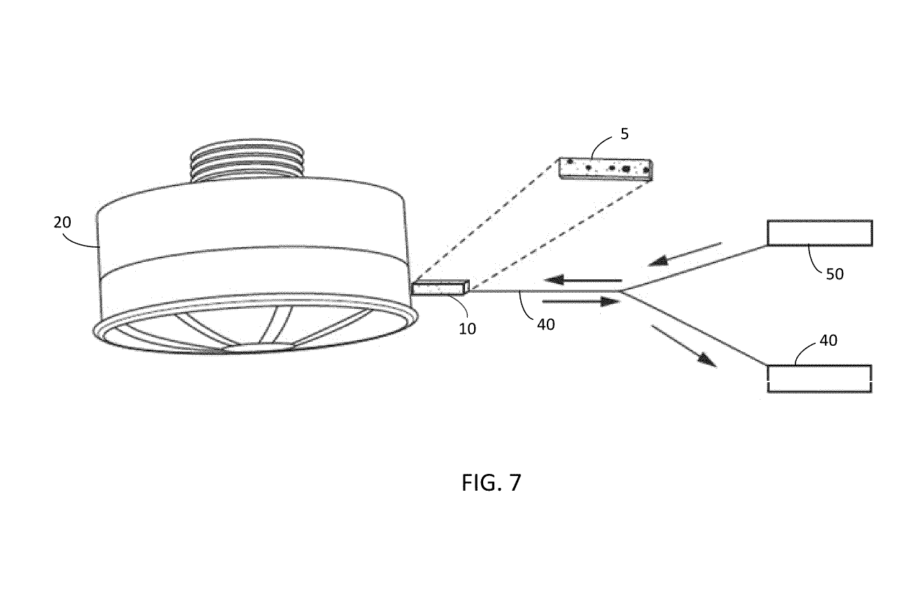

Cobinamide/support material composite materials can be either embedded within the canister (for removal of toxic gases) or placed into a small holder (for monitoring toxic gas concentrations). FIG. 6A shows an assembled sensor holder 10 constructed to hold a sensor 5 (e.g., a pellet or filter paper impregnated with cobinamide and/or a cobinamide derivative), and optionally a minor. FIG. 6B shows the disassembled holder 10. The holder 10 comprises two portions 11, 12, each portion including a recess 13, 14. Portions 11, 12 include cooperatively placed apertures 15A, 15B, 16A,16B to receive fastening means 17, for example, screws, bolts, or clips. Sensor holder 10 further includes a port 18 defining an aperture fluidly connected to the recess 13, 14 to permit gas to flow through the sensor and contact the cobinamide-impregnated pellet or filter paper. Sensor holder 10 also includes a connection port 19 for connecting a fiber optic cable. The holder 10 can then be either embedded or externally attached to a respirator canister and connected through fiber optic cables to a detector 40, such as mini-spectrometer, and a light source 50. See in particular FIG. 7, which shows how a sensor 5 comprising cobinamide and a support material, such as a sol-gel or a filter paper disk (glass fiber or cellulose), can be positioned into a holder 10 which will be attached externally to a gas-mask canister 20. A fiber-optic 30, such as a bifurcated fiber-optic, in optical communication with a detector 40 and a light source 50, can be connected in optical communication with the pellet holder 10 to provide a diffuse reflectance device capable of detecting concentrations of analyte (e.g., HCN gas) in the ppm range. Suitable light sources include, for example, low-power light-emitting diodes. In some embodiments, the light source may be an RGB color sensor, e.g., a light source including red, green, and blue photodiodes. In some embodiments, a minor is also positioned in the holder 10. The mirror may be placed such that the sensor 5 is positioned between the mirror and the connection port 18. The minor can increase reflectance by reflecting light that passes through the sensor 5 back through the sensor to the fiber-optic. When the specific analyte of interest is measured by the spectrometer at or above a threshold amount, a signal, e.g., an audible and/or visual indicator, will tell the user that the canister has almost reached its end-of-service-life.

In one embodiment, a sensor including a cobinamide-loaded material is used to monitor breakthrough effluent from a gas mask canister. In some examples, the disclosed cobinamide-loaded materials detected breakthrough effluent of HCN and/or H₂S with comparable response times to commercial detectors used for breakthrough monitoring in niosh-approved standard respirator testing procedures.

### II. METHODS OF MAKING COBINAMIDE-LOADED MATERIALS

Cobinamide is encapsulated within or impregnated into a support material. Suitable support materials include a porous silica matrix, cellulose paper, and glass fiber paper. When the material will be used to detect cyanide, the support material may be impregnated with monocyanocobinamide (CN(H₂O)Cbi). When the analyte is other than cyanide, the support material is typically impregnated with cobinamide (OH(H₂O)Cbi).

In some embodiments, cobinamide or a cobinamide derivative (e.g., monocyanocobinamide) is impregnated into paper, such as a cellulose filter paper or a glass fiber filter paper. In some embodiments, the support material has a thickness from 100-500 μm, and a pore size from 0.01 μm to 100 μm. Suitable cellulose filters include, but are not limited to Fisherbrand® P8 qualitative cellulose filter paper (200 μm thick, 20-25 μm particle retention). Suitable glass fiber filter papers include, but are not limited to, Gelman Sciences A/E borosilicate glass fiber filter paper (binder free, 300 μm thick, 1 μm pore size.

A cobinamide solution is applied to the paper, for example by pipetting or spraying the solution onto the paper. In some embodiments, the cobinamide solution has a concentration suitable to provide a reflectance spectrum having a high signal-to-noise ratio while retaining suitable sensitivity. Suitable concentrations may be within a range of 40-60 μM, such as a concentration of 45-55 μM, 49-51 μM, or 50.0±0.2 μM. The volume of applied solution depends, at least in part, on the diameter and/or thickness of the support material. In one example, 15 μL of cobinamide solution was applied to a 6-mm disk of cellulose filter paper. Desirably, the volume is sufficient to wick over the surface and be absorbed by the paper without oversaturation. The cobinamide-impregnated paper is dried before use.

In some embodiments, cobinamide is encapsulated in a silica matrix. The silica matrix may be prepared by a sol-gel process. Various silicate precursors (such as tetraethyl- or tetramethyl-orthosilicate; TEOS or TMOS) in the presence of surfactants may be used to produce a silica monolith with morphologies optimized for 1) the encapsulation of various concentrations of cobinamide, 2) diffusion of analyte(s) through the matrix, 3) binding of the analyte(s) to cobinamide, and 4) detection of the change in absorbance of cobinamide. In certain embodiments, an acid catalyst (e.g., hydrochloric acid) is combined with a silicate precursor, a solvent (e.g., ethanol/water), and a surfactant to produce a sol-gel pellet. The pellet may have an average pore size of 0.1 to 500 nm, such as an average pore size of 1-250 nm, 5-100 nm, or 25-75 nm.

### III. EXAMPLES

### Chemicals and Materials:

Aquohydroxocobinamide [OH(H₂O)Cbi], Co(III)) was synthesized from hydroxocobalamin as described previously (Broderick et al., J. Biol. Chem. 2005, 280:8678-8685). KCN was purchased from Fisher Scientific (granular; certified ACS) and was dissolved in 1 M NaOH (Fisher Scientific, certified). Stock HCN gas was purchased from Butler Gas (Pittsburgh) at a concentration of 495.0 (±2%) ppm. Fisherbrand® P8 Qualitative filter paper (200 μm thick, 20-25 μm particle retention) and Gelman Sciences A/E Borosilicate Glass fiber filter paper (without binder, 330 μm thick, 1 μm pore size) were used as the support media. Deionized water was from an 18 MΩ-cm using an in-line water system (Thermo Scientific Micropure).

### Preparation of Cobinamide Solution:

A bench-top UV-VIS spectrometer (Thermo Scientific Evolution 300) was used to determine the concentration of cobinamide stock solutions using a molar extinction coefficient of 2.8×10⁴ M⁻¹cm⁻¹ [25]. The concentration of dicyanocobinamide [(CN₂)Cbi] was determined using a molar extinction coefficient at 583 nm of 10450 M⁻¹cm⁻¹. Binding of one cyanide ion to OH(H₂O)Cbi was achieved by incubating equimolar amounts of cobinamide and KCN overnight at 4° C. CN(H₂O)Cbi stock solutions were diluted in deionized water to 50.0±0.2 μM for fixing onto the paper substrates.

### Preparation of Paper Substrates:

Filter paper was cut into uniform 6-mm diameter circles. A volume of 15 μL 50 μM Cbi was placed onto the center of each piece of paper leading to approximately 0.9 μg CN(H₂O)Cbi per paper. The CN(H₂O)Cbi solution diffused uniformly on the paper substrate and was allowed to dry fully at room temperature (˜21° C.). Some samples were tested at 50 and 85% relative humidity (% RH) by incubating the Cbi-spotted paper at the respective % RH for 4 h at 21.0° C. using an environmental chamber (Caron Model 6010-1) prior to the beginning of the experiment.

The average absorbance of CN(H₂O)Cbi on cellulose filter paper (measured at 500 nm) was 0.13±0.02 nm (F(R) value equal to 0.049±0.001) with a 14% CV. The average absorbance on glass fiber filter paper was 0.18±0.03 (F(R) value equal to 0.087±0.002) with 15% CV for glass fiber paper. These values are based on 30 samples for both cellulose and glass fiber filter paper with ± values calculated by sample standard deviation using

$$s = \sqrt{\frac{\sum {( x - \vec{x} )}^{2}}{n - 1} .}$$

### Diffuse Reflectance Instrumentation:

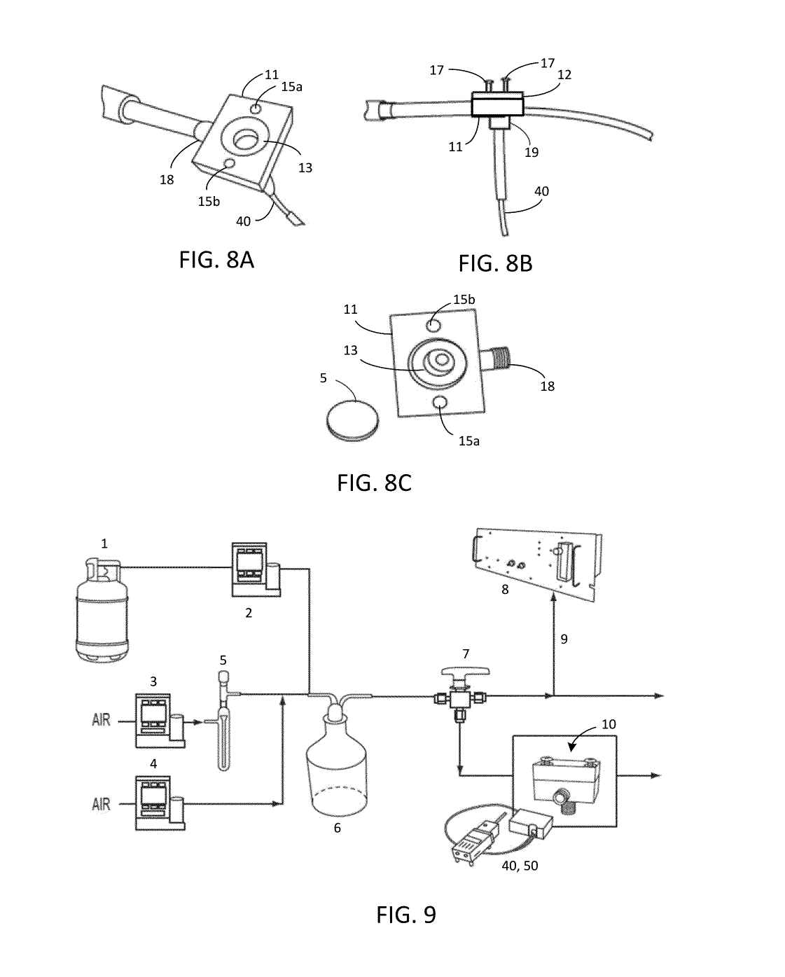

An Ocean Optics USB4000 UV-VIS-ES miniature spectrometer (200-850 nm) was used for diffuse reflectance measurements. The Cbi-impregnated paper circles were inserted into a custom-made holder constructed of black, Delrin® plastic. A 12.7 mm diameter minor (Thor Labs BB05-E02) was incorporated into a screw-top lid at top of the holder, above the paper circle. Two holes in each side of the holder allowed HCN to pass through the holder; the holder is shown in FIGS. 8A-8C. The common end of a bifurcated fiber optic (Ocean Optics, core diameter 600 μm, fused silica) was connected to the bottom of the holder directly under the filter paper. The two distal branches of the fiber were connected to a tungsten halogen light source (Ocean Optics LLS, 215-2500 nm) and the USB spectrometer, respectively.

### HCN Flow Experimental Setup:

The experimental setup is shown in FIG. 9. Three mass flow controllers 2, 3, 4 (MFCs; alicat.com) regulated air flow, the HCN concentration flowing from a HCN storage canister 1, and the % RH based on air passing through a water bubbler 5. Air and HCN were mixed in a gas blender 6, and subsequently passed through a three-way valve 7, which directed a portion of the blended gas through line 9 to a detector 8. The % RH was measured with a humidity sensor prior to each experiment and the HCN concentration was confirmed using an HCN-specific electrochemical detector 8 (Interscan RM series, 0-50.0 ppm). Experiments were performed at a carrier gas flow rate of 1 liter per minute (LPM) at 25% RH (unless otherwise specified) at room temperature. HCN gas from the cylinder 1 was diluted with air to the desired HCN concentration (1-10 ppm), and the final concentration was verified using the Interscan HCN detector 9. 1 ppm was the lowest concentration at which an accurate dilution could be obtained. All tubing was made of Teflon (PFTE) material.

The system was initially flushed with air at the desired % RH (no HCN) for 1-2 h before the experiment. The system was evaluated by the Interscan detector to ensure a reading of 0.0 ppm HCN. A blank paper circle was then placed in the holder. The reflectance signal from the blank was defined as 100% reflectance at each wavelength. A piece of CN(H₂O)Cbi-impregnated paper was then placed in the holder and the appropriate reflectance spectrum recorded. In some experiments, the reflectance spectrum of CN(H₂O)Cbi-doped paper was designated as the “blank” when the goal was to monitor changes in the CN(H₂O)Cbi spectrum. The paper circles were allowed to equilibrate with the desired % RH for 30 min in the holder prior to beginning the experiment. Initially, the three-way valve 7 was set to allow air to flow to the Interscan HCN detector 8. Once the Interscan sensor read the desired HCN concentration, the valve 7 was switched to direct the air to flow over the sensor in the sensor holder 10. The valve switching time was designated as the start of the experiment. An Ocean Optics® miniature USB spectrometer 40 and light source 50 can be operably connected to the system.

### Example 1

### Preparation of Cobinamide-Doped Pellets

One example of an inexpensive, miniature and versatile (for additional gases) sensor that may be used as an ESLI for a gas mask canister is described below. In one implementation, a sol-gel process was tailored to obtain appropriate porosity, pore volume, pH, hydrophobicity/hydrophilicity, surface area, etc. A sol-gel was produced at room temperature and pressure. An acid or base catalyst can be used in the sol-gel process. It was found that an acid catalyst (HCI) produced dense sol-gel monoliths, whereas a base catalyst produced a powdery substance.

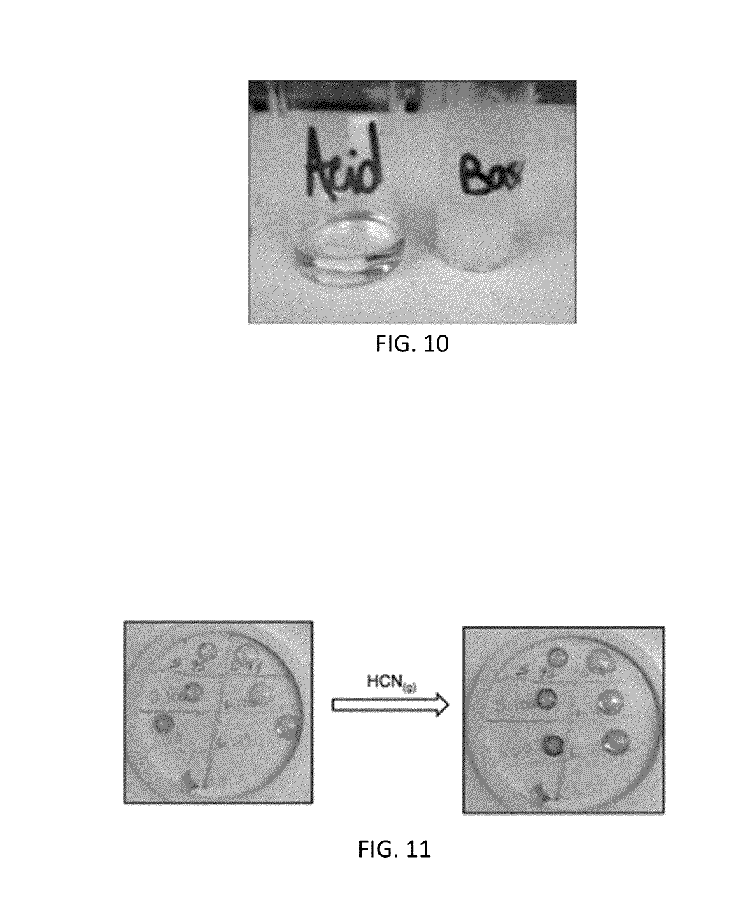

An acid catalyst was chosen (FIG. 10, which shows acid versus base sol-gel solutions of TEOS, ethanol, H₂O, cobinamide, and a surfactant). The ratios of TEOS, ethanol, water, hydrochloric acid, cobinamide were optimized (1:4:4:0.2) to yield a suitable sol-gel pellet. Porosity analysis was performed and it was found that the pore size was approximately 2 nm. To increase the pore size (to yield a faster response time of the sensor) and to produce crack-free pellets, it was found that adding a millimolar to micromolar concentration of an anionic, neutral or cationic surfactant such as, respectively, sodium dodecyl sulfonate, poly(ethylene) glycol, or dodecyl trimethyl ammonium bromide yielded the desirable results. In this example, a nonionic polyoxyethylene-polyoxypropylene block copolymer (Pluronic® F-68, Sigma-Aldrich) was used at a TEOS:surfactant ratio of 1:0.005 to 1:0.001. The concentration of cobinamide was also optimized. The final concentration of cobinamide was 50 μM. Various volumes of the sol-gel solution were pipetted into well plates to determine the most appropriate thickness of the pellet once it dried down.

Several different sizes of the cobinamide-doped pellets were prepared with various concentrations of cobinamide and their responses to HCN exposure (color change from orange to purple, indicating the binding of the cyanide ion to cobinamide) were compared to further optimize the system. See, e.g., FIG. 11, which shows cobinamide-doped sol-gel pellets with and without HCN). This led to the design of the pellet holder, including the addition of the mirror to the holder, as shown above in FIG. 6.

A HCN dosing system was constructed, and the optimized pellets were introduced to various concentrations of HCN. As shown in FIG. 11, the system yielded acceptable results for detection of HCN.

### Example 2

### System Optimization with Cellulose and Glass Fiber Filters

For the cellulose filter paper, the integration time of the spectrometer was set at 600 ms, with a boxcar width and scans-to-average set to 5. The integration time for an individual scan was selected to give a signal 85% of the spectrometer's saturation level (limited by the A/D converter to 65 k counts), while the number of scans-to-average was chosen to improve S/N. For the glass fiber filter paper, which was thicker than the cellulose paper and allowed more light to be reflected back to the detector, the integration time was set to 300 ms with a boxcar width and scans-to-average set to 5. The spectrometer software measures the intensity of reflected light returning back to the detector from the paper through the bifurcated fiber optic and converts the data to an apparent absorbance.

Absorbance was converted to reflectance (Equation 2) and then to the Kubelka-Munk Function (Equation 1) by:

$$\begin{matrix}R = {10}^{- A} & Equation 2 \\ F ( R ) = \frac{{( 1 - R )}^{2}}{2 R} = K / S & Equation 1\end{matrix}$$

where R is reflectance, K is the absorption coefficient and S is the scattering coefficient.

The flow rate over the paper was set to 1 LPM to avoid back pressure build-up in the sensor holder. This flow rate has no correlation to the air flow through a canister but was chosen to focus on studying the binding between HCN and CN(H₂O)Cbi. The small size of the sensor box combined with the 1 LPM flow rate yields a time constant of a few seconds for a step change in HCN concentration.

The optimal concentration of CN(H₂O)Cbi to pipette onto the paper substrate was found to be 50.0±0.2 μM. This concentration yielded a reflectance spectrum with a high signal to noise ratio without being too concentrated, which would result in lower sensitivity in detecting small changes of the reflectance spectrum.

The optimal volume of CN(H₂O)Cbi placed onto the paper circles was 15.00 μL±0.02, which completely wicked over the surface of the paper without oversaturating and leaving CN(H₂O)Cbi residue outside the paper. This volume allowed the paper substrates to completely dry in a reasonable amount of time.

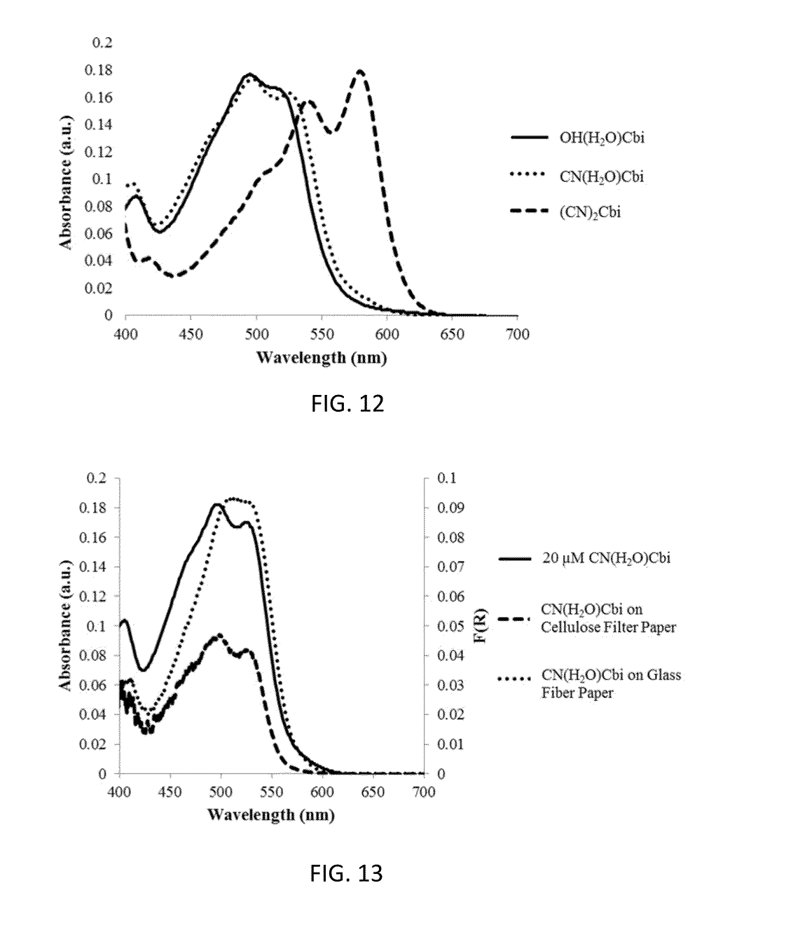

The absorbance spectra for OH(H₂O)Cbi, CN(H₂O)Cbi, and (CN)₂Cbi in aqueous solution at 20 μM are shown in FIG. 12. The absorbance spectra for OH(H₂O)Cbi and CN(H₂O)Cbi are similar, thus the changes in absorbance spectrum when trace amounts of CN⁻ bind to OH(H₂O)Cbi are not analytically useful. However, when a second cyanide ion binds to CN(H₂O)Cbi, a peak appears at 583 nm, absorption at 450-500 nm decreases, and an isosbestic point occurs at 531 nm.

The absorption spectrum of a 50 μM CN(H₂O)Cbi solution is similar to the diffuse reflectance spectra of CN(H₂O)Cbi on cellulose and glass fiber papers (FIG. 13). The spectra of Cbi both in aqueous solution and on paper are similar. A higher K/S value (Equation 1) for CN(H₂O)Cbi is observed on the glass fiber paper than on the cellulose filter paper, likely due to the greater thickness of the glass fiber paper reflecting more light to the detector.

### Example 3

### Cobinamide Detection of HCN with Cellulose Filter Paper

The average blank signal on cellulose paper at 583 nm in terms of the Kubelka-Munk function was 2(±1)×10⁻⁰⁶, or in terms of absorbance: 0.0002±0.0007 a.u. (n=10). Statistically the LOD (LOD=3σ+ x̅) using cellulose filter paper at 583 nm in terms of the Kubelka-Munk function was 1.5×10⁻⁰⁵, or 0.002 a.u.

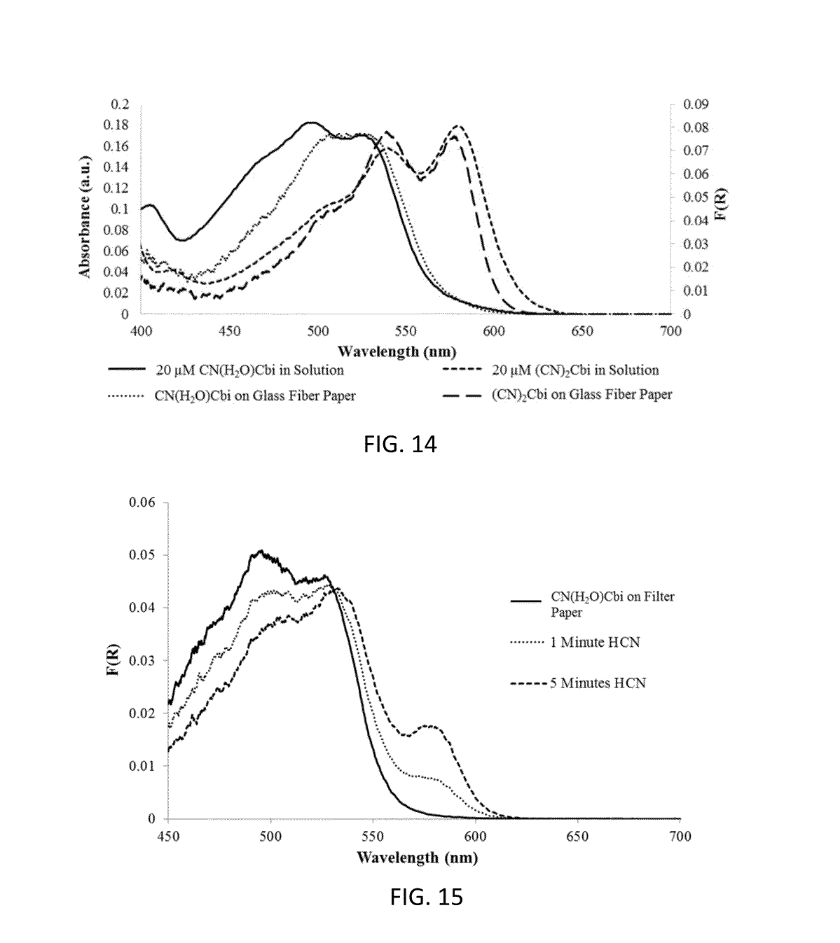

FIG. 14 shows the spectral changes that resulted from the conversion of CN(H₂O)Cbi to (CN)₂Cbi when excess KCN (in 1 mM NaOH) was added to a CN(H₂O)Cbi solution in a cuvette (absorbance spectrum) and when 15 ppm HCN flowed over a Cbi-impregnated glass fiber paper for 15 min (diffuse reflectance). There was a slight variation between the absorbance spectrum and diffuse reflectance spectrum, but the characteristic features of the dicyano complex were apparent by diffuse reflectance. Thus, substitution of the water ligand by cyanide occurs readily for the CN(H₂O)Cbi on the paper.

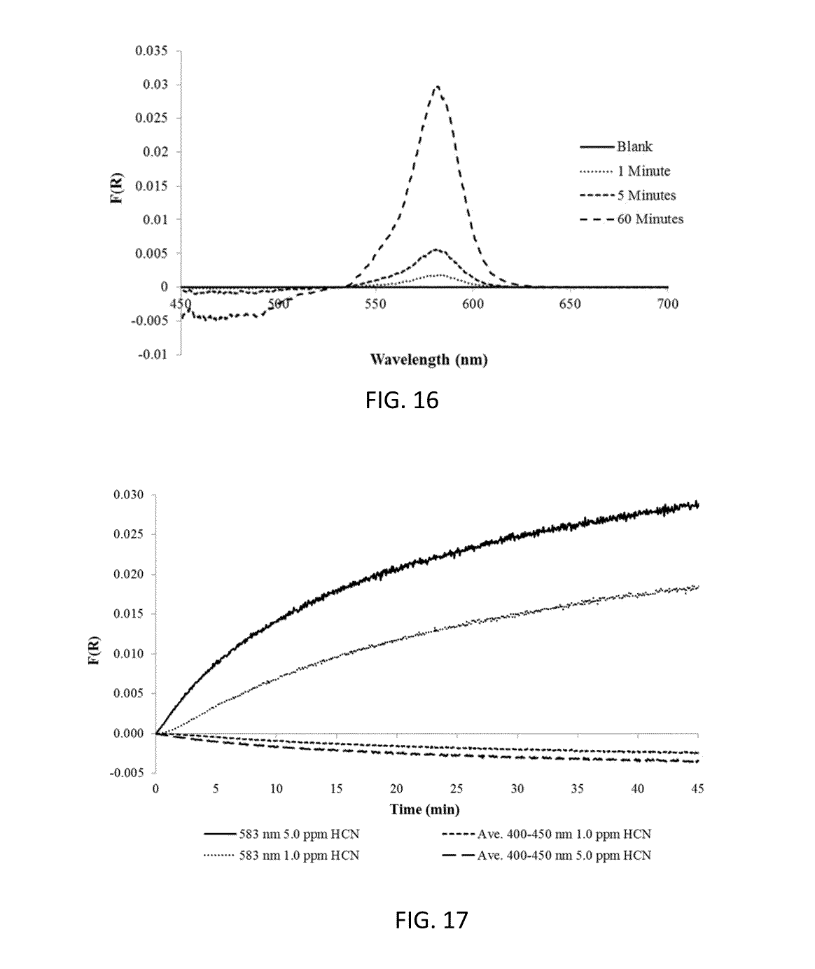

FIG. 15 shows the response of CN(H₂O)Cbi on cellulose filter paper when exposed to 5 ppm HCN after 1 and 5 min at 25% RH. The Kubelka-Munk function was plotted for the diffuse reflectance spectra. The increased signal at 583 nm, decreased signal at 450-500 nm and isosbestic point at 531 nm were apparent. This is more easily seen in FIG. 16 where the spectrum of CN(H₂O)Cbi on filter paper was the blank, creating difference spectra.

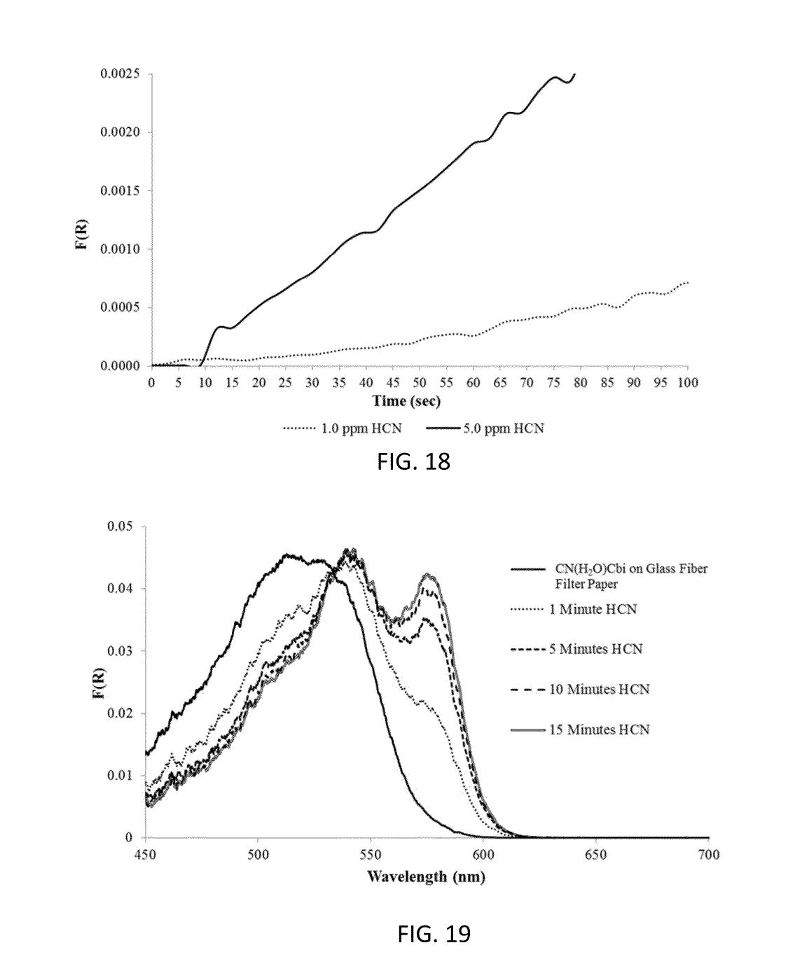

Two F(R) vs. time trends, one at 583 nm and the other at the average response between 450-500 nm, are seen in FIG. 16. T=0 corresponds to the time at which the valve was turned to direct the HCN gas over the sensor. As expected, exposure to 5 ppm HCN showed a higher signal at 583 nm (and lower signal at 450-500 nm) than exposure to 1 ppm HCN (FIG. 17). FIG. 18 displays an expansion of FIG. 17 as the initial response when HCN passed over the sensor. With an estimated dead time of less than 2 sec for the start of the cyanide flow, a measurable response at 583 nm appeared in 10 sec for a 5 ppm exposure. A slower response was observed for a 1 ppm exposure, with a noticeable increase in signal occurring at approximately 20 sec.

### Example 4

### Cobinamide Detection of HCN with Glass Fiber Filter Paper

The average blank signal on glass fiber filter paper measured at 583 nm in terms of the Kubelka-Munk function was 1(±1)×10⁻⁰⁶, or in terms of absorbance: 0.0002±0.0007 a.u. (n=10). Statistically the LOD (LOD=3σ+ x̅) using glass fiber filter paper measured at 583 nm in terms of the Kubelka-Munk function was 1.4×10⁻⁰⁵, or 0.002 a.u.

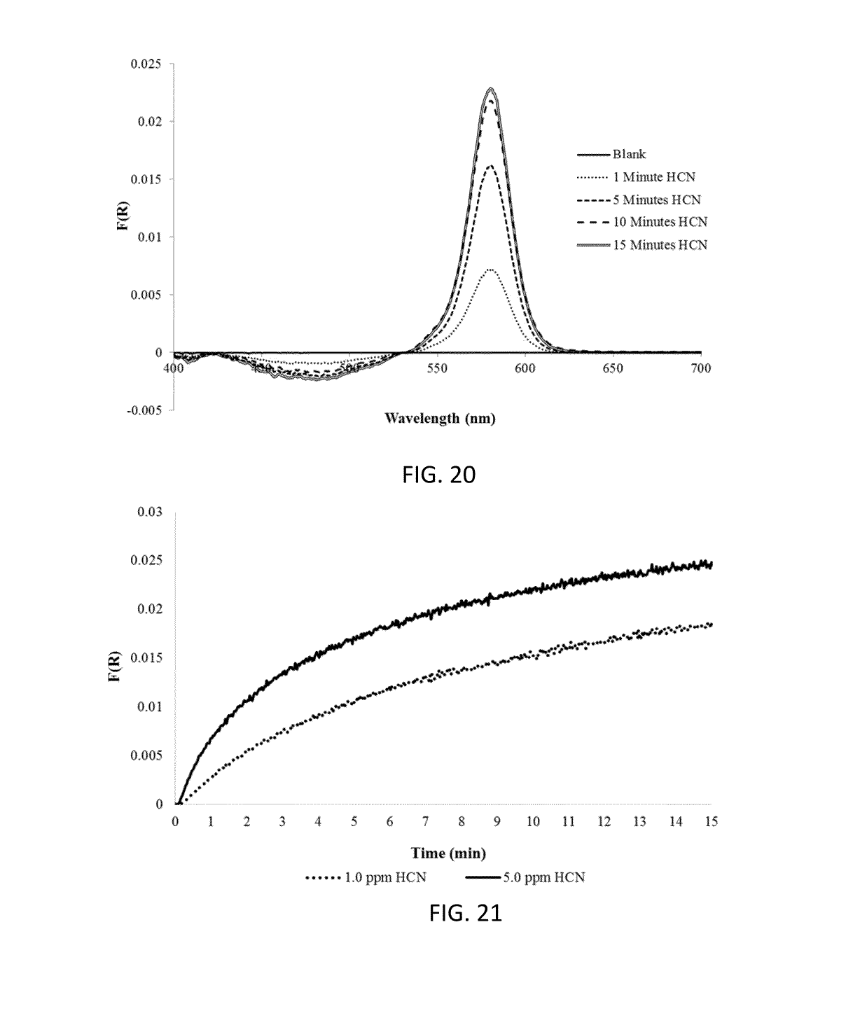

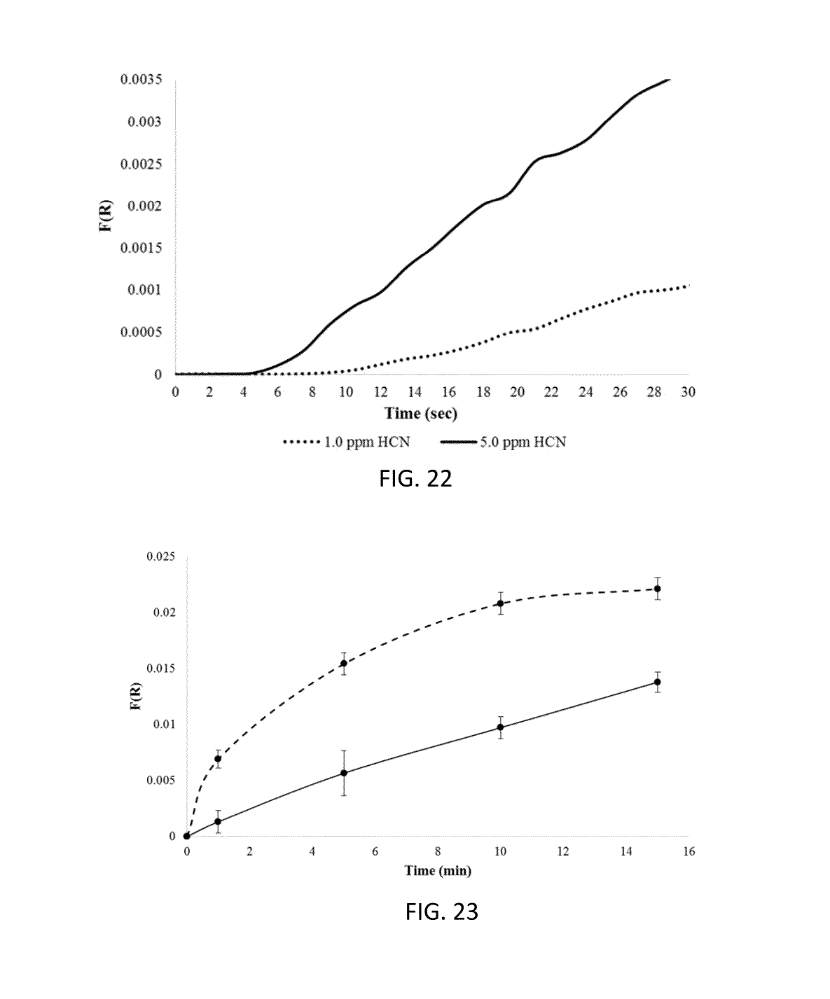

Using the glass fiber paper and plotting the Kubelka-Munk function for the diffuse reflectance spectra, a similar pattern was observed: the 583 nm signal increased and the 450-500 nm signal decreased when 5 ppm HCN was present at 25% RH (FIG. 19). Unlike the signal from cellulose paper, the signal from the glass fiber paper levels off at longer HCN exposure times, with a near steady-state signal observed within 10 min of exposure. This observation is likely attributed to the larger surface area of the thicker glass fiber paper and more cobinamide available to complex with CN⁻. This is also more easily visualized in FIG. 20 where the spectrum of CN(H₂O)Cbi on glass fiber filter paper is the blank, creating difference spectra. Similar to the cellulose paper, FIG. 21 shows F(R) vs. time at 583 nm for 5 ppm and 1 ppm, where a larger signal is observed for the 5 ppm HCN exposure. FIG. 22 shows a rapid initial response occurring within 5 sec for 5 ppm HCN exposure, while the initial rapid rise occurs over ˜10 sec for the 1 ppm exposure. Compared to cellulose filter paper, the glass fiber paper displays initial response times approximately half those of the cellulose paper.

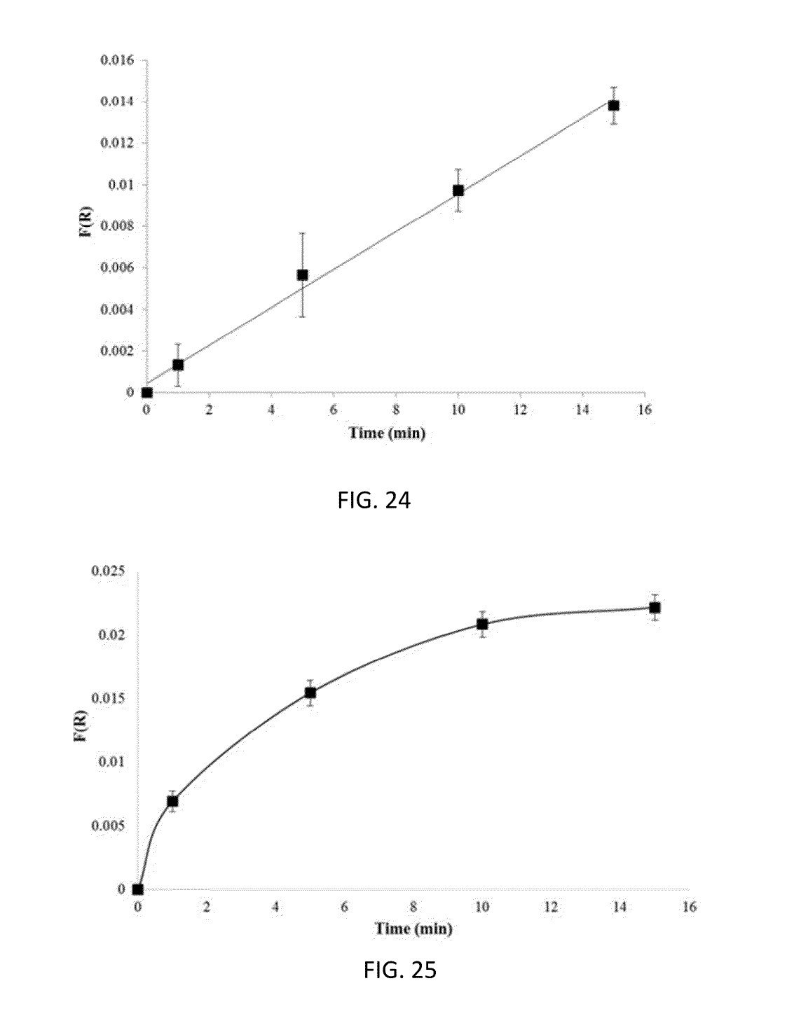

A comparison between the response of CN(H₂O)Cbi on cellulose filter paper (▪) and glass fiber filter paper (♦) when exposed to 5 ppm HCN for 1, 5, 10, and 15 min is shown in FIG. 23 and Table 1. The response with the glass fiber filter paper was significantly larger than with the cellulose filter paper. Although 5 ppm of HCN is the primary concentration of interest, the glass fiber paper displayed increased Kubelka-Munk values (F(R)) at every HCN concentration for each time interval when compared to cellulose filter paper (see FIGS. 24 and 25 for the cellulose and glass fiber filter paper results, respectively). For 5 ppm HCN, the Kubelka-Munk function is linear for cellulose paper but nonlinear for glass fiber paper with respect to time (FIGS. 24 and 25, respectively). The saturation of the response suggests that the amount of reacted cobinamide complex was approaching the total amount of cobinamide immobilized in the paper. The linear behavior for cellulose paper indicated that the amount of reacted cobinamide was small with respect to the total amount of cobinamide over the 15 min of exposure. These differences suggest that the interaction of CN(H₂O)Cbi with the substrate affects its response to HCN.

TABLE 1

| Time | F(R) at 583 nm | 95% C.I. | F(R) at 583 nm | 95% C.I. |
|---|---|---|---|---|
| (min) | Cellulose F.P. | n = 3 | Glass Fiber F.P. | n = 6 |
| 0 | 7.E−07 | 7.E−07 | 1.00E−06 | 1.E−08 |
| 1 | 0.001 | 0.001 | 0.0069 | 0.0008 |
| 5 | 0.006 | 0.002 | 0.016 | 0.001 |
| 10 | 0.010 | 0.001 | 0.021 | 0.001 |
| 15 | 0.0138 | 0.0009 | 0.022 | 0.001 |

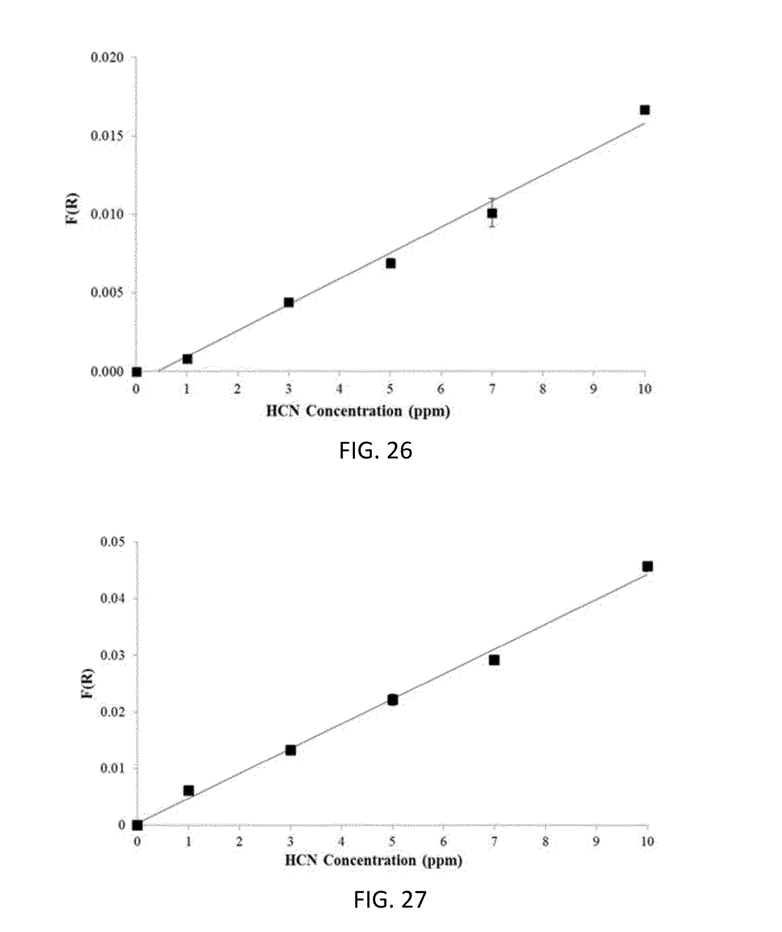

The Kubelka-Munk function signal was approximately linear with respect to HCN concentration after 1 min (FIG. 26) as well as after 15 min (FIG. 27). Deviations were most likely due to the nonhomogeneous medium. One of the assumptions of the Kubelka-Munk function is that the substrate is isotropic and homogenous, which was not necessarily the case here (Dzimbeg et al., Technical Gazette 2011, 117-224). A more linear response using the Kubelka-Munk function was observed after 15 min exposure, most likely due to the system being at steady state at each concentration. Although the Cbi-impregnated filter papers can detect HCN concentrations of less than 5 ppm, the focus of this study was the STEL of HCN and it was determined that HCN at 5 ppm could be detected in less than 1 min using the CN(H₂O)Cbi—impregnated paper.

### Example 5

### Effect of Percent Relative Humidity on HCN Detection

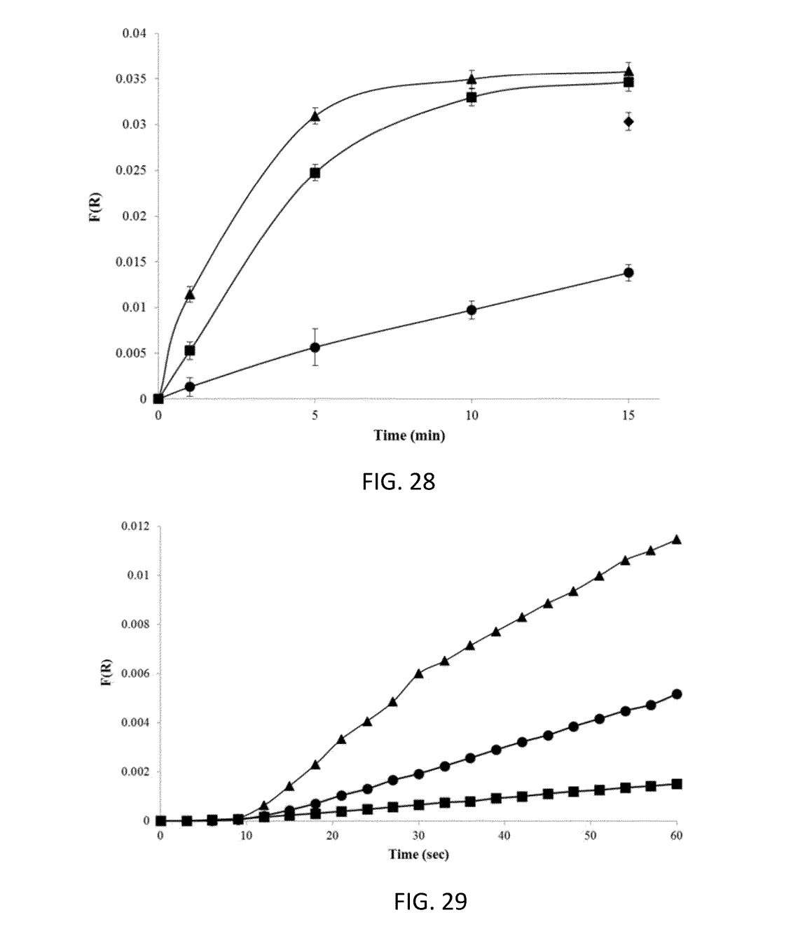

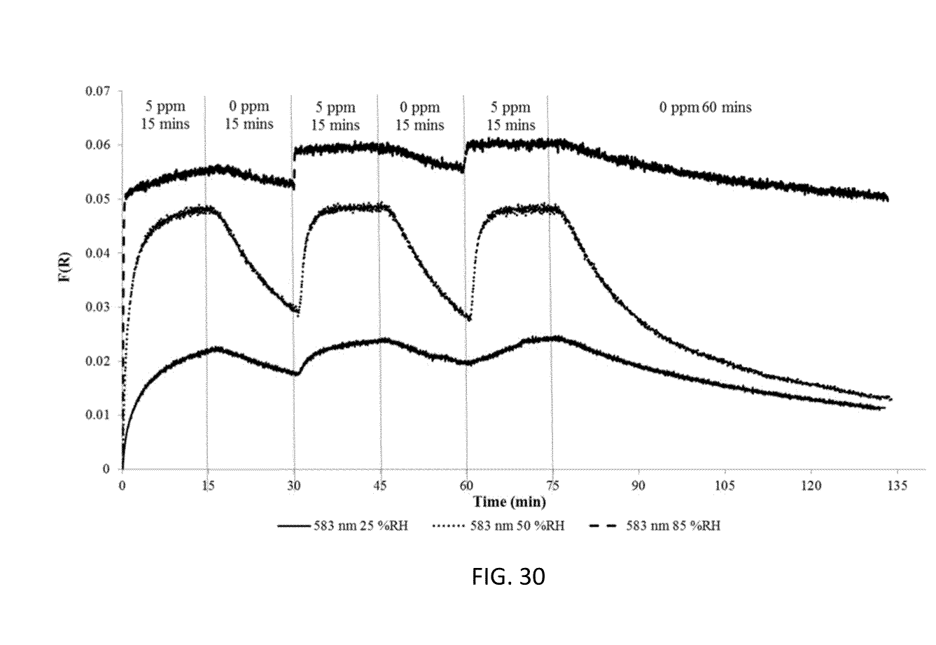

The effect of % RH on the paper's detection performance was quantified for RH values of 50 and 85%. These humidity values (including 25% RH) were evaluated because respirators are used in a wide range of climates with various temperatures and humidity. FIG. 28 shows the response on cellulose filter paper as a function of time for varying % RH (25% RH (♦), 50% RH (▪) and 85% RH (▴)), with the initial response expanded in FIG. 29, Table 2, and Table 3. A data point was added to FIG. 30 indicating the average F(R) at 583 nm for 25% RH after 60 min (0.0303±0.0002) was similar to the F(R) values of 50 and 85% RH after only 15 min (0.035±0.001 and 0.0358±0.0001, respectively). At each % RH, the signal responded at approximately the same time (˜10 sec) after exposure to HCN. The higher sensitivity of the CN(H₂O)Cbi-impregnated paper for high relative humidity is clearly evident in this figure.

TABLE 2
Average F(R) Cbi Response on Cellulose
Filter Paper for 25, 50 and 85% RH

| | F(R) at | | F(R) at | | F(R) at | |
|---|---|---|---|---|---|---|
| | 583 nm | 95% | 583 nm | 95% | 583 nm | 95% |
| Time | for 25% | C.I. | for 50% | C.I. | for 85% | C.I. |
| (min) | RH | N = 3 | RH | N = 3 | RH | N = 3 |
| 0 | 4.E−07 | 9.E−07 | 7.E−06 | 7.E−06 | 9.E−06 | 2.E−06 |
| 1 | 0.001 | 0.001 | 0.005 | 0.001 | 0.0115 | 0.0009 |
| 5 | 0.006 | 0.002 | 0.0248 | 0.0009 | 0.0309 | 0.0009 |
| 10 | 0.010 | 0.001 | 0.0330 | 0.0009 | 0.035 | 0.001 |
| 15 | 0.0138 | 0.0009 | 0.035 | 0.001 | 0.036 | 0.001 |
| 60 | 0.030 | 0.001 | | | | |

TABLE 3

| Time | F(R) at 583 nm | F(R) at 583 nm | F(R) at 583 nm |
|---|---|---|---|
| (s) | for 25% RH | for 50% RH | for 85% RH |
| 0 | 4E−06 | 9E−06 | 8E−06 |
| 3 | 4E−06 | 5E−06 | 1E−05 |
| 6 | 5E−05 | 2E−05 | 1E−05 |
| 9 | 9E−05 | 6E−05 | 0.0001 |
| 12 | 0.0002 | 0.0002 | 0.0006 |
| 15 | 0.0002 | 0.0005 | 0.0014 |
| 18 | 0.0003 | 0.0007 | 0.0023 |
| 21 | 0.0004 | 0.0010 | 0.0033 |
| 24 | 0.0005 | 0.0013 | 0.0041 |
| 27 | 0.0006 | 0.0017 | 0.0049 |
| 30 | 0.0007 | 0.0019 | 0.0060 |
| 33 | 0.0008 | 0.0022 | 0.0065 |
| 36 | 0.0008 | 0.0026 | 0.0071 |
| 39 | 0.0009 | 0.0029 | 0.0077 |
| 42 | 0.0010 | 0.0032 | 0.0083 |
| 45 | 0.0011 | 0.0035 | 0.0089 |
| 48 | 0.0012 | 0.0039 | 0.0094 |
| 51 | 0.0013 | 0.0042 | 0.010 |
| 54 | 0.0014 | 0.0045 | 0.0106 |
| 57 | 0.0014 | 0.0047 | 0.0110 |
| 60 | 0.0015 | 0.0052 | 0.0115 |

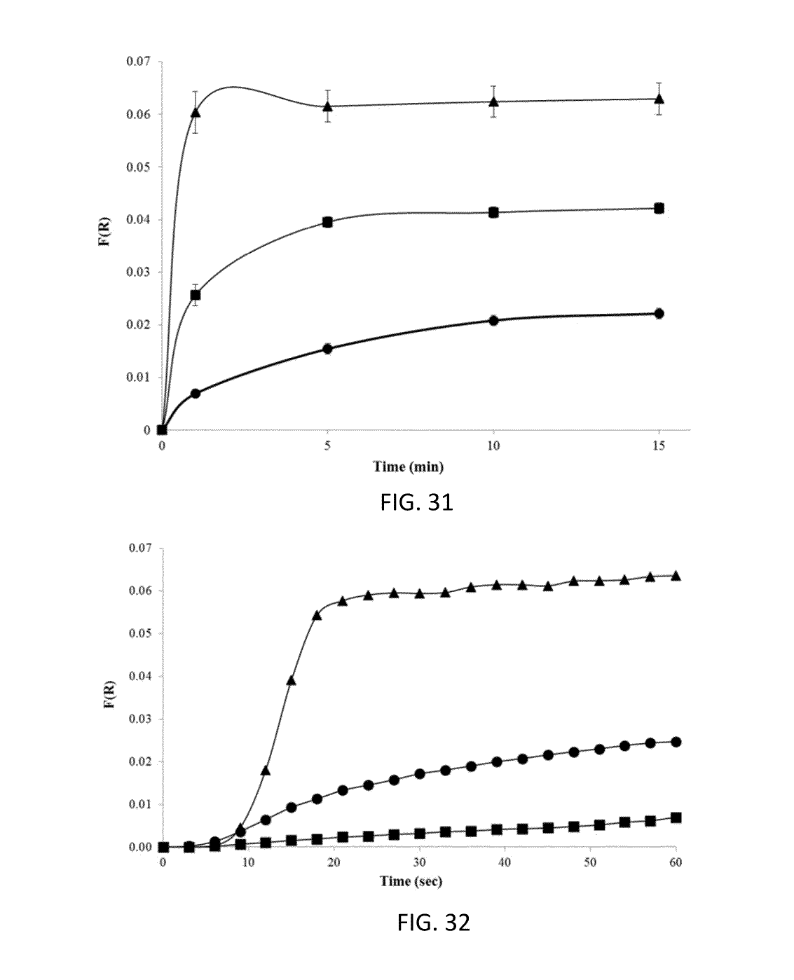

FIG. 31 shows data for the glass fiber (25% RH (♦), 50% RH (▪) and 85% RH (▴)), with the initial response expansion and data in FIG. 32, Table 4, and Table 5. These F(R) values were much higher than those observed for the cellulose filter paper. The response for 25% RH started to plateau after 10 min, while the response for 50 and 85% RH started to plateau after 5 min for 50% and close to 1 min for 85% RH, reaching steady state much more rapidly than cellulose paper. The cellulose and glass fiber filter papers both showed a larger signal and a faster response at the wavelengths of interest at higher % RH. This observation is attributed to the ability of the papers to absorb water vapor, creating a more solution-like medium for the reaction between HCN and cobinamide, and possibly adding a proton acceptor for the HCN.

TABLE 4
Average F(R) Cbi Response on Glass Fiber
Filter Paper for 25, 50 and 85% RH

| | F(R) at | | F(R) at | | F(R) at | |
|---|---|---|---|---|---|---|
| | 583 nm | 95% | 583 nm | 95% | 583 nm | 95% |
| Time | for 25% | C.I. | for 50% | C.I. | for 85% | C.I. |
| (min) | RH | N = 6 | RH | N = 3 | RH | N = 3 |
| 0 | 1.E−06 | 3.E−06 | 1.E−06 | 7.E−06 | 1.E−06 | 7.E−06 |
| 1 | 0.0069 | 0.0008 | 0.026 | 0.002 | 0.060 | 0.004 |
| 5 | 0.015 | 0.001 | 0.0395 | 0.001 | 0.062 | 0.003 |
| 10 | 0.021 | 0.001 | 0.0413 | 0.001 | 0.062 | 0.003 |
| 15 | 0.022 | 0.001 | 0.0421 | 0.001 | 0.063 | 0.003 |

TABLE 5

| Time | F(R) at 583 nm | F(R) at 583 nm | F(R) at 583 nm |
|---|---|---|---|
| (seconds) | for 25% RH | for 50% RH | for 85% RH |
| 0 | 5E−07 | 3E−05 | 2E−05 |
| 3 | 2E−06 | 0.0002 | 4E−05 |
| 6 | 0.0002 | 0.0013 | 0.0002 |
| 9 | 0.0006 | 0.0037 | 0.0045 |
| 12 | 0.0011 | 0.0065 | 0.0181 |
| 15 | 0.0016 | 0.0093 | 0.0391 |
| 18 | 0.0019 | 0.0113 | 0.0543 |
| 21 | 0.0023 | 0.0133 | 0.0577 |
| 24 | 0.0026 | 0.0145 | 0.0591 |
| 27 | 0.0030 | 0.0158 | 0.0596 |
| 30 | 0.0032 | 0.0172 | 0.0594 |
| 33 | 0.0036 | 0.0180 | 0.0596 |
| 36 | 0.0037 | 0.0190 | 0.0609 |
| 39 | 0.0041 | 0.0200 | 0.0615 |
| 42 | 0.0043 | 0.0208 | 0.0614 |
| 45 | 0.0045 | 0.0216 | 0.0612 |
| 48 | 0.0048 | 0.0223 | 0.0623 |
| 51 | 0.0052 | 0.0230 | 0.0624 |
| 54 | 0.0058 | 0.0238 | 0.0626 |
| 57 | 0.0062 | 0.0244 | 0.0633 |
| 60 | 0.0070 | 0.0247 | 0.0635 |

The large value of the binding constant for cyanide with CN(H₂O)Cbi (10⁸) implies that the cyanide binding should be irreversible. However, FIG. 30 shows that the complex can slowly revert back to CN(H₂O)Cbi when HCN is removed from the gas stream. HCN was cycled on and off at 15 min increments with an additional 60 min absence of HCN at the end of the experiment. Surprisingly, the rate of loss of cyanide was greatest at 50% RH. The kinetics of the loss of cyanide is substantially slower than the kinetics of binding. In terms of an end-of-service-life sensor, a brief exposure to HCN may not trigger the sensor due to insufficient change in the reflectance spectrum. However, the sensor would remain sensitive and respond rapidly upon a repeated exposure to HCN.

### Example 6

### Sulfide Detection

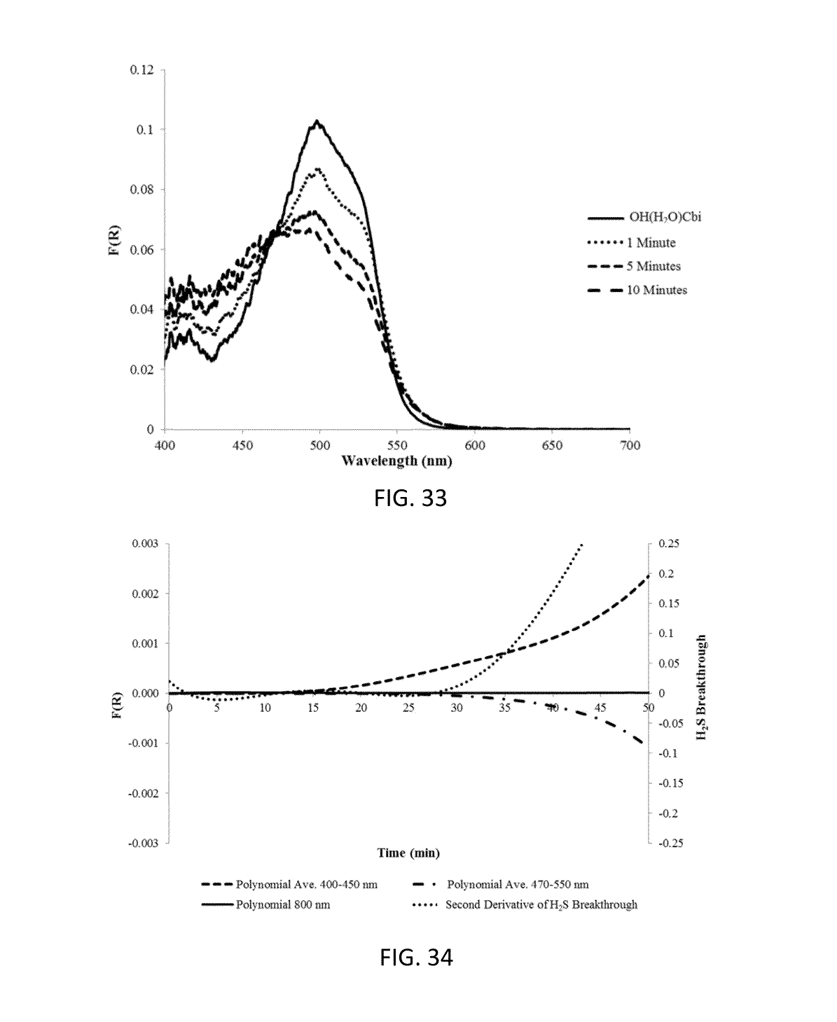

Cobinamide (OH(H₂O)Cbi) was fixed onto 6-mm glass fiber paper and placed in the sensor holder, above the bifurcated fiber optic (as previously described). 10.0 ppm H₂S, the NIOSH REL for H₂S, was passed over the paper. The results are shown in FIG. 33. The spectral changes are similar to that found in solution, meaning the impregnation of OH(H₂O)Cbi on paper responds with similar spectral changes to that of OH(H₂O)Cbi in solution. Additionally, spectra for exposure to H₂S are different than those observed for exposure to HCN. This finding allows the possibility for the sensor to be used as both a HCN ESLI and H₂S ESLI since two different respiratory protection canisters are required for these two gases.

The OH(H₂O)Cbi-impregnated glass fiber paper can sufficiently detect breakthrough of 10.0 ppm H₂S through a cartridge specified for H₂S exposure. The paper sensor was placed downstream of the canister, along with a H₂S—specific electrochemical detector, widely used with NIOSH certrification and approval STPs. Two trends (and a reference wavelength) were monitored over time—the average of 470-550 nm and 400-450 nm. The electrochemical detector data is displayed as the second derivative to closely monitor the breakthrough point (FIG. 34). The cobinamide-impregnated glass fiber paper sensor shows a similar trend to the H₂S-specific electrochemical detector.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A sensor for detecting gaseous chemical agents, comprising:
a support material; and
an effective amount of cobinamide and/or a cobinamide derivative impregnated within the support material.

2. The sensor of claim 1, wherein the support material comprises a glass fiber paper, a cellulose paper, a silica matrix, carbon, titania, or alumina.

3. The sensor of claim 1, comprising an effective amount of monocyanocobinamide.

4. The sensor of claim 1, wherein the effective amount is within a range of 0.005-0.5 nmol/mm³, based on a volume of the support material.

5. A respirator canister, comprising:
a housing;
a sorbent filter disposed in the housing;
an end-of-life sensor comprising a support material and an effective amount of cobinamide and/or a cobinamide derivative impregnated within the support material; and
a detector for measuring absorbance or reflectance of light by the sensor, wherein changes in the absorbance or reflectance of light reaching the detector are indicative of the sorptive capacity of the sorbent filter.

6. The respirator canister of claim 5, wherein the end-of-life sensor is disposed in the housing.

7. The respirator canister of claim 5, wherein the end-of-life sensor is secured externally to the housing.

8. The respirator canister of claim 5, further comprising a visual and/or audible indicator configured to indicate when an absorbance of light measured by the sensor reflects a concentration of cyanide and/or other gaseous chemical agents that exceeds a threshold amount.

9. The respirator canister of claim 5, further comprising a light source for irradiating the sensor and an optical fiber having a first end in optical communication with the sensor and a second end in optical communication with the light source.

10. The respirator canister of claim 9, wherein the optical fiber is bifurcated so that the second end includes at least two end portions, one of the end portions optically communicating with the light source and the other of the end portions optically communicating with the detector.

11. The respirator canister of claim 5, wherein the detector includes a spectrometer.

12. A method for detecting an analyte, comprising:
contacting a sample comprising an analyte capable of binding to cobinamide and/or a cobinamide derivative with a sensor according to claim 1; and
detecting a change in color of the sensor.

13. The method of claim 12, wherein detecting a change in color of the sensor includes measuring the absorbance or reflectance of light by the sensor.

14. The method of claim 12, wherein the analyte is cyanide, cyanogen, sulfide, nitrite, nitric oxide, or a combination thereof.

15. The method of claim 12, wherein the analyte is cyanide, and the sensor comprises monocyanocobinamide.

16. The method of claim 12, wherein the effective amount is within a range of 0.005-0.5 nmol/mm³, based on a volume of the support material.

17. A method for removing gaseous chemical agents from an environment, comprising:
providing a sensor according to claim 1; and
exposing the sensor to the environment, whereby the cobinamide and/or the cobinamide derivative binds to a gaseous chemical agent in the environment.

18. The method of claim 17, wherein the gaseous chemical agent is cyanide, cyanogen, sulfide, nitrite, nitric oxide, or a combination thereof.

19. The method of claim 17, wherein the environment comprises an interior space of a respirator canister.

20. The method of claim 17, wherein the effective amount is within a range of 0.005-0.5 nmol/mm³, based on a volume of the support material.
